(19) United States
(12) Patent Application Publication
(10) Pub. No.: US 2026/0228753 A1
(43) Pub. Date: Aug. 6, 2026

(54) SYSTEMS AND METHODS FOR AUTOMATING THE SUPPORT PROCESS

(71) Applicant: Allan Adam Miller, Martinez, CA (US)

(72) Inventor: Allan Adam Miller, Martinez, CA (US)

(21) Appl. No.: 19/223,066

(22) Filed: May 30, 2025

Related U.S. Application Data
(60) Provisional application No. 63/654,124, filed on May 31, 2024.

(51) Int. Cl. G06Q 30/015

(52) U.S. Cl. CPC G06Q 30/015

(57) ABSTRACT

Methods and systems are described for providing automated detection, diagnosis, solution, and verification for support problems that can occur on supported devices, using an agent on the devices that can execute code from a script and communicate information about the solution to a server. The server can control multiple agents and browse data from the agents and can update and prioritize agent scripts based on a master script database. A simulation engine can reproduce configurations and event sequences from devices to reproduce problems, assist with script development, test scripts, and generate completely new problems. A script generator can use generative artificial intelligence to generate or assist with the generation of new scripts based on reproduced problems. The script generator and simulation engine can form a generative adversarial network. Machine learning systems can be used to predict future support needs on the device.

### CROSS-REFERENCE TO RELATED APPLICATION

This application claims the benefit of U.S. Provisional Patent Application No. 63/654,124, filed May 31, 2024, which is incorporated by reference herein in its entirety.

### BACKGROUND OF THE INVENTION

The support process can be largely manual and can require effort by both the end user of the device being supported and the support agent providing support for the device. The result can be a time-consuming, expensive, and frustrating experience for all concerned. Automating any part of the support process may be needed to provide relief from the frustration and expense.

### SUMMARY OF THE INVENTION

The support process for devices can be viewed by both the end users of the devices and the support agents responsible for supporting the devices as a necessary evil. The end user may be trying to complete a task and is suddenly inconvenienced by a device that is not working as it should, or as desired, and is causing an unexpected and unwanted delay. The support agent may have little visibility into the symptoms and causes of the problem and wants to solve the issue as quickly as possible to have a happy end user. Both sides therefore can have little interest in a long-term solution that will prevent the problem from reoccurring. The support agent's attempts to solve the issue may be hampered by the end user's attempts to solve the issue on their own, without telling the support agent what they are doing. The entire process often can take place over a voice channel between the provider and consumer (phone support), which can lead to miscommunication, with further delay and frustration.

Device support can often apply to general purpose computers such as desktop and laptop computers, mobile devices such as phones and tablets, and servers such as virtual machines or dedicated servers providing cloud-based services. However, with the proliferation of the “Internet of Things,” device support has gained relevance in a wider variety of devices including appliances such as refrigerators and dishwashers, wearable computing such as watches and fitness trackers, home security such as cameras and alarms, home automation such as thermostats and lighting systems, environmental monitoring such as air quality and radiation sensors, retail systems such as checkout and payment processing, and automobiles with intelligent head-end systems.

Despite the obvious benefits and popularity of automating some or all of the support process, many attempts so far to do so have been largely unsuccessful. There are a number of reasons for this, some of which are detailed below.

In order to automate the solution to problems, the implementation of the automation may need to recognize the problem and implement a solution or workaround to fix the problem or mitigate its effects. In the case of a true solution, the problem may be prevented from happening again, and in the case of a workaround, the problem may happen again but can be addressed the same way. In some cases, the end user may not be aware that the problem has occurred and has been addressed, and in some cases, the user may be aware that the problem has occurred but is still likely to be appreciative that the problem has been addressed without further manual effort. There are some problems for which solutions may not be automated, for example, hardware failures, but an automated support process may still be helpful in diagnosing the problem and guiding the end user along the path to a solution.

One issue with automation can be that the vast majority of problems are not well understood. Since end users can be focused on the quickest path to getting back to the task at hand, they may not be interested in time spent on understanding the true issue in order to solve the problem more efficiently in the future. Similarly, support agents may be compensated for the number of tickets they close, so they may have little or no motivation to understand the true root cause of issues. Understanding and fixing the true root cause could reduce the number of future incidents, which could result in greater end user satisfaction, but could reduce the number of closed tickets and therefore the compensation of the support agents. The end result of this lack of understanding of the problems can be that the “solutions” applied by support agents tend to be unnecessarily broad and overly disruptive, such as restarting the device, killing processes, reinstalling software, and so on. These solutions may eventually fix the underlying issue by accident, but may not provide any insight into what was actually at fault and what sort of minimally invasive solution could have quickly and easily addressed the issue.

Another outcome of the use of these “blunt tools” for “solving” issues can be the use of “maintenance” solutions such as deleting unused files, clearing application caches, defragmenting storage media, and so on. These sorts of solutions can sometimes provide temporary relief for some performance issues such as low memory or overuse of the processor, but usually use significant resources to implement and may have few, if any, lasting benefits.

When a solution is truly automated by determining the root cause to detect it and a point solution to address it, the solution may only have a relatively short “half-life” during which it is valuable. This can be because the most annoying and prevalent problems can also be the problems that are likely to have a native fix provided reasonably quickly by the vendors of the operating system and applications. Once this fix is provided by the vendors and becomes widely available, the automated solutions for the associated problems may no longer be as important. The availability and distribution of these fixes can follow a similar pattern to that seen in radioactive decay, hence the use of the term “half-life” to describe it. More prevalent and disruptive problems can demand more immediate response with automated solutions, but those automated solutions may have a shorter half-life. The half-life of solutions can be a useful metric for categorization; there is the “short tail” of more critical issues, and the “long tail” of issues that the vendors are unlikely to fix rapidly, if ever. The short-tail automated solutions can be expensive to produce since they are needed on a compressed time scale, but their utility can drop rapidly with the passage of time.

To effectively create an automated solution, the solution developer may need to reproduce the problem locally, for several reasons. The developer may need to be able to experiment to find the root cause of the problem and diagnose it correctly, determine the solution for the problem and apply it reliably, and understand the scope of the problem to limit the application of the solution to cases where it is needed. The developer may also need to be able to test that the automated solution operates correctly and solves the problem in a variety of environments. The developer may need to be able to do regression testing, to verify that the solution continues to work correctly as the environment (operating system and applications) are updated over time. Finally, the developer may need to be aware of when the problem is solved outside of the automated solution (starting the half-life expiration of the solution described above), to plan for de-prioritization and eventual removal of the automated solution from the system.

However, reproducing a problem locally can often be difficult. The problem may be sensitive to the versions of the operating system and applications, or the combination of certain applications. In addition to version sensitivity, the problem may depend on certain configuration settings in the operating system and applications. The problem may also depend on the sequence of operations that are initiated by the end user or by external events, the timing of those operations, or even events that happen on other devices in the environment. This complexity can necessitate accurate recording of both the environment configuration and event sequencing associated with the problem. As described before, neither the end user nor the support agent may have the time or interest to use such a detailed recording, and even if this interest existed, neither party may have the tools required to make the recording. Additionally, the amount of data in such a recording can be prohibitively large for storing and transmitting the data from the end user device to the support agent (and ultimately the solution developer).

The talent required by a solution developer can be expensive. The solution developer may need to be well versed in the applications used by end users, including their configuration and operation, as well as their interfaces to one or more operating systems. The developer may also need to understand the underlying infrastructure of these operating systems and be comfortable with developing code to implement the detection and solution of the problems. This developer may also require the ability to reproduce the problems, and can often require familiarity with aspects of system administration for the devices. The developer may also be required to work with the support agents and their tools and may need to interface directly with end users. This variety of skills may not be available in a single person and may instead require a team of developers with a variety of skills.

Even if support automation is implemented well and addresses many end user issues on devices without manual intervention, good visibility of the activity of the automation and its effectiveness may be required to justify the expense of implementation of the automation system, particularly in an enterprise environment where the accounting for the system may not be managed by the end users of the system. The monitoring tools providing the visibility may need to give sufficient detail for effective accounting on the use of the system, depending on what sort of contractual arrangements are made for the use of the system.

Effective support automation may require anticipating issues that are likely to happen before they impact end users. For example, hardware issues, licensing issues, and software updates can all require advance planning and budgeting to address effectively. The support automation system may need to have the ability to make reasonably accurate predictions and recommendations in these and other areas.

Support automation may not be a “one size fits all” type of activity. It may depend on the device type; for example, a security issue that is detected on a server device can likely be more significant than the same issue that is detected on an end user desktop device. It may depend on the class of user of the device, for example, an issue with a videoconferencing system that is detected on the device of the CEO of a corporation can likely be more significant than the same issue that is detected on a server device with no display. The automated solutions may need to incorporate considerations like these.

Existing systems have not addressed most of these considerations and have therefore fallen short of the promise of support automation. What is needed is support automation systems and methods that address these issues to provide an efficient, reliable, and cost-effective solutions to problems that plague end users and support agents. The present invention meets this need.

At least one aspect of the present disclosure is directed to a method of supporting a device. In some embodiments, the method can initialize, by a script on the device, a detection of an event based on a problem. The method can diagnose, by the script, based on the detection of the event, the problem. The method can apply, by the script, based on the diagnosing, a solution for the problem. The method can determine, by the script, a success indicator for the solution. The method can write, by the script, to a database, a record of at least one of the initialization, the diagnosis, the application, and the success indicator.

At least one aspect of the present disclosure is directed to a method of supporting a device. In some embodiments, the method can determine, by a script on the device, a success indicator of applying an automated solution for a problem. The method can record, in a database, the success indicator. The method can extract, from the database, a frequency for the solution and a recency for the solution. The method can compute, based on the frequency and the recency, a priority for the solution. The method can use the priority to determine an ordering for applying the solution.

At least one aspect of the present disclosure is directed to a method of supporting a device. In some embodiments, the method can record, by an agent on the device, a plurality of events. An event of the plurality can comprise at least one of a system event, a user interface event, and an external event. The method can label, by the agent, the event with a time stamp. The method can detect, by the agent, based on an error event, an error status associated with the plurality of events. The method can label, by the agent, the plurality of events with the error status. The method can filter, by a filtering agent, the plurality of events to create a filtered plurality of events. The method can compress, by a compressor, the filtered plurality of events to create a compressed plurality of events. The method can write, by the agent, based on the error status, the compressed plurality of events to a database. The filtering agent can be trained based on the error status and the plurality of events. The compressor can be trained based on the error status and the plurality of events.

At least one aspect of the present disclosure is directed to a method of simulating a device. In some embodiments, the method can receive, from an agent on the device, a configuration and an event stream. The method can deploy a simulation based on the configuration. The method can invoke a plurality of actions on the simulation based on the event stream. The method can record a plurality of events on the simulation resulting from the plurality of actions. The method can write the plurality of events into a database. The configuration can be based on a second configuration of the device. The event stream can be based on a second plurality of events on the device.

In some embodiments, the method can additionally maintain a plurality of containers in a database. The method can additionally use the plurality of containers for the deployment.

In some embodiments, the method can additionally identify, based on the configuration, a root cause of a problem. The method can additionally identify, based on the event stream, a solution for the problem. The method can additionally create, based on the root cause and the solution, a script.

In some embodiments, the method can additionally deploy a second simulation based on the configuration. The method can additionally run the script on the second simulation. The method can additionally invoke a second plurality of actions on the second simulation based on the event stream. The method can additionally determine a success indicator for the script.

In some embodiments, the method can additionally configure a generative adversarial network. The method can additionally apply the generative adversarial network until the success indicator indicates that the script solves the problem. The creation process of the script can be a generator of the generative adversarial network. The second simulation can be a discriminator of the generative adversarial network.

At least one aspect of the present disclosure is directed to a method. In some embodiments, the method can receive, from a first device, a configuration and an event stream. The method can receive, from a support system, a support requirement for the first device. The method can configure a machine learning system. The method can train the machine learning system based on the configuration, the event stream, and the support requirement. The method can receive, from a second device, a second configuration and a second event stream. The method can evaluate, with the machine learning system, the second configuration and second event stream. The method can predict, based on the evaluation, a second support requirement for the second device.

### BRIEF DESCRIPTION OF THE DRAWINGS

The accompanying drawings are not intended to be drawn to scale. Where a single drawing spans multiple sheets, connectors between the sheets are labeled with a letter. For the purposes of clarity, not every component may be labeled in every drawing. In the drawings:

FIG. 1 is a block diagram illustrating the automation pipeline and process flow, in accordance with some embodiments of the present invention.

FIG. 2 is a block diagram illustrating the local agent solution architecture, in accordance with some embodiments of the present invention.

FIG. 3 is a flowchart illustrating the local agent solution process, in accordance with some embodiments of the present invention.

FIG. 4 is an illustration of the user interface of an application that has not yet encountered an example problem, in accordance with some embodiments of the present invention.

FIG. 5 is an illustration of the user interface of an application that has encountered an example problem, in accordance with some embodiments of the present invention.

FIG. 6 is a block diagram illustrating the script update architecture for solution scripts, in accordance with some embodiments of the present invention.

FIG. 7 is a flowchart illustrating the prioritization of automation scripts, in accordance with some embodiments of the present invention.

FIG. 8 is a block diagram illustrating the reporting and dashboard architecture for the local agent and dashboard server, in accordance with some embodiments of the present invention.

FIG. 9 is a block diagram illustrating the simulation engine architecture, in accordance with some embodiments of the present invention.

FIG. 10 is a block diagram illustrating the simulation data recording and action architecture for a simulation instance, in accordance with some embodiments of the present invention.

FIG. 11 is an illustration of the user interface of an application that is about to encounter an example problem with no automated solution, in accordance with some embodiments of the present invention.

FIG. 12 is an illustration of the user interface of an application that is encountering an example problem with no automated solution, in accordance with some embodiments of the present invention.

FIG. 13 is an illustration of an example system event stream, in accordance with some embodiments of the present invention.

FIG. 14 is a block diagram illustrating a neural network evaluating a system event stream on a device that is not encountering a problem, in accordance with some embodiments of the present invention.

FIG. 15 is a block diagram illustrating a neural network evaluating a system event stream on a device that is encountering a problem, in accordance with some embodiments of the present invention.

FIG. 16 is a block diagram illustrating the local agent architecture for recording, compressing, and transmitting system event stream to a server, in accordance with some embodiments of the present invention.

FIG. 17 is a block diagram illustrating the simulation engine architecture for receiving and processing system event stream data, in accordance with some embodiments of the present invention.

FIG. 18 is a flowchart illustrating the process of receiving and processing event stream data from the local agent at the simulation engine, in accordance with some embodiments of the present invention.

FIG. 19 is a block diagram illustrating the architecture for generating a script to solve a previously unsolved problem, in accordance with some embodiments of the present invention.

FIG. 20 is a block diagram illustrating the predictive analytics architecture for predicting support needs, in accordance with some embodiments of the present invention.

FIG. 21 is an illustration of the user interface of a dashboard displaying device information based on end user devices that are not encountering significant support issues, in accordance with some embodiments of the present invention.

FIGS. 22A and 22B are illustrations of the user interface of a dashboard displaying support automation information based on end user devices that are not encountering significant support issues, in accordance with some embodiments of the present invention.

FIG. 23 is an illustration of the user interface of a dashboard displaying predictions for support needs based on end user devices that are not encountering significant support issues, in accordance with some embodiments of the present invention.

FIG. 24 is an illustration of the user interface of a dashboard displaying device information based on end user devices that are encountering significant support issues, in accordance with some embodiments of the present invention.

FIGS. 25A and 25B are illustrations of the user interface of a dashboard displaying support automation information based on end user devices that are encountering significant support issues, in accordance with some embodiments of the present invention.

FIG. 26 is an illustration of the user interface of a dashboard displaying predictions for support needs based on end user devices that are encountering significant support issues, in accordance with some embodiments of the present invention.

FIG. 27 is a block diagram illustrating the architecture for a computing device, in accordance with some embodiments of the present invention.

FIG. 28A is a block diagram illustrating the local agent architecture, in accordance with some embodiments of the present invention.

FIG. 28B is a block diagram illustrating the AI server architecture and simulation server architecture, in accordance with some embodiments of the present invention.

FIG. 28C is a block diagram illustrating the dashboard server architecture, in accordance with some embodiments of the present invention.

### DETAILED DESCRIPTION

In an embodiment, the present invention can provide automated detection, diagnosis, solution, and verification for support problems that can occur on supported devices. This can be done using an agent on the devices that can execute code from a script to set up event detection for a problem, respond to the events in the detection, apply a solution, and test to see if the solution actually solved the problem. The agent can communicate information about the solution to a server, which can in turn be used to control multiple agents and browse data from the agents. An update server can also be used to control updates to the agent scripts from a master script database. The server can prioritize the scripts for the agents depending on their frequency of use, how recently they have been used, and other characteristics. The agent can also do a local prioritization based on the same or other criteria. The prioritization may increase the efficiency of how the agent solves issues.

In an embodiment, an agent or a server can have an interface to an external ticketing system. The ticketing system can track both automated and non-automated detection and solution of problems and may be able to facilitate the coordination of a support team and communications with end users of the supported devices.

In an embodiment, an agent can record user inputs, external environmental events, and system level events in a consolidated event stream. The event stream can have timing information that can help to synchronize event streams from multiple devices. The event stream can be stored locally on the device and may also be filtered or compressed. The event stream can be sent to a server for further analysis and may be anonymized or have personally identifiable information (PII) removed. The filtering and data compression of the event stream may be implemented or assisted by a machine learning system that may be trained using a number of event streams. The machine learning systems used in this way may be updated or retrained based on event streams recorded on the device or other devices and may also be updated or retrained based on automated problem solutions that are developed or deployed to an agent.

In an embodiment, a simulation server can be used to configure device environments and simulate user inputs and external environmental events. The configuration of environments may use container-based systems to better support multiple types of configurations and deployments of the simulated systems. The simulation of user inputs and external environmental events may be implemented using off-the-shelf simulation tools or custom systems and may be driven by event streams from devices or inputs that are generated randomly or parametrically, or some combination of all of these methods.

In an embodiment, the simulations may be used to reproduce a problem that has happened on a device. This may be done by using one or more event streams from a device to simulate the conditions leading to the problem, verifying that the system events in the simulation track the system events from the device, and verifying that the events associated with the detection of the problem on the device are observed in the simulation. Reproducing a problem in this way may be helpful in understanding the root causes and possible solutions for the problem, which may be helpful in developing an automated solution for the problem. Reproducing a problem in this way may also be helpful in testing that a proposed automated solution for the problem actually solves the problem, and it may also be helpful in regression testing to verify that an automated solution does not have undesirable effects on a device or interact badly with other automated solutions or other software on the device.

In an embodiment, the simulations may be used to test the operation of a proposed automated solution script. This may be done by reproducing a problem as described previously, while having the solution automation system running in the simulation with the proposed script installed. Testing the solution this way may relieve the script developer from having to perform mundane and repetitive work to set up the problem conditions, manually cause the problem, and manually observe the result. Testing the solution in this way may also enable a fully or partially automated process for implementing script development.

In an embodiment, the simulations may be used to simulate the actions of a group of humans using a group of devices, and observing problems that arise. This can be done by using random or parametric sequences to drive a set of typical end user actions, for example, exercising an email application by randomly or parametrically selecting operations that include composing, saving, sending, deleting, and selecting messages. Simulating end user activity in this way may be helpful in reproducing issues that are difficult to capture or record on end user systems or issues that are rare or depend on timing or race conditions involving multiple devices. Simulating end user activity in this way may also help to identify issues that have not yet occurred on end user devices and may help to develop automated solutions that can help to prevent them from ever occurring on end user devices.

In an embodiment, a generalized event detection may be used to detect problems for which no specific detection or diagnosis criteria exist yet, and therefore for which no automated solution exists yet. This may be done by detecting events normally associated with errors, such as error dialogs, error messages, error logs, audible warnings, system faults, application faults, unexpected application exits, end user ticket submissions, or end user behavior repeated multiple times in an attempt to solve an issue. Once these generalized events are detected, the simulation system may be used to reproduce the associated problem as described previously, which may be helpful in characterizing the problem, solving the problem, or developing an automated solution for the problem. Detecting generalized events can be done on an end user device, in a cloud service device, or in a simulated device in the simulation system.

In an embodiment, the simulation system may be used to anticipate support problems in an environment with managed devices, such as an enterprise installation. This may be done by using the simulation system to deploy a number of simulation systems in the one or more configurations used for the managed devices, then using random or parametric sequences to drive typical end user actions on the applications installed on the simulation systems, as described previously. Support issues may be detected using either existing support automation scripts or generalized event detection, and these detections may be helpful in characterizing what support issues are likely to arise for end users of the managed devices, before the issues actually arise and affect the end users. This knowledge may help to anticipate and prevent the issues or address them quickly, which may help to lower support costs and increase end user satisfaction.

In an embodiment, the simulation system may have commercial value outside of support automation in the form of application development. This may be done by installing an application, which may either be a released version or a release candidate, on one or more machines in a simulation environment with a variety of configurations. The simulation may then use random or parametric sequences to drive typical end user actions on the application. The simulation may also use regression test sequences to drive known troublesome end user actions on the application. Application issues may be detected using generalized event detection, and the resulting detections may reveal problems in the application that were previously unknown. Fixing these problems may enhance the stability and reliability of the application for actual end users.

In an embodiment, a machine learning system can be trained to anticipate support problems before they happen. This may be done by training the system with inputs based on an event stream, and classification based on event data where problems were previously detected or not detected. The problem detection may be based on specific event detection associated with known problems, generalized event detection as described previously, or a combination of the two. The resulting anticipation of problems may be useful in reporting potential issues, filtering event data, compressing event data, generating software alerts, or other useful actions based on predicting upcoming issues.

In an embodiment, a script generation system can be used to fully or partially automate the development of scripts to automate the solution of support problems. This can be done by using a generative artificial intelligence (AI) system to generate proposed scripts, based on a library of existing scripts and event stream data characterizing the problem. The scripts can then used as proposed scripts directly or reviewed and modified by a human before proceeding. The simulation system can be used to test the proposed scripts, as described above, in an environment that may correspond to the device environment where the problem being solved was observed. The simulated test may report error messages, behaviors, or other diagnostics that may be useful in modifying or improving the script. The generative AI system may be fully automated in generating proposed scripts, or it may be used in conjunction with a human developer as a “copilot” to assist or accelerate the script development process.

In an embodiment, a script generation system as described previously may be combined with a simulation system as described previously to automate the testing of the proposed scripts and provide feedback that may be used to refine and improve the generation of the proposed scripts. The cycle of generating and testing the scripts can be repeated in what may be known as a generative adversarial network (GAN), where the script generation system may be the generator and the simulation system may be the discriminator. GANs have been shown to be effective in improving the results of generative techniques to arrive at better results more quickly, so this application of a GAN may result in the development of better support automation scripts more quickly.

In an embodiment, the event streams from supported devices may be used as input to predictive learning systems to provide business insights that may be useful for managing a business or managing the supported devices. For example, the event streams may help to predict what hardware issues might be more likely to arise on the supported devices, which may help to pre-order parts to address the issues, which may in turn provide opportunities for negotiating better prices with longer lead times. As another example, the event streams may help to predict what software upgrades might be more likely to arise on the supported devices, which may help to schedule the upgrades in a way that is more convenient for both the support staff and the end users. As yet another example, the event streams may help to predict what software licensing changes might be needed on the supported devices, which may help to negotiate volume discount agreements with the software vendors.

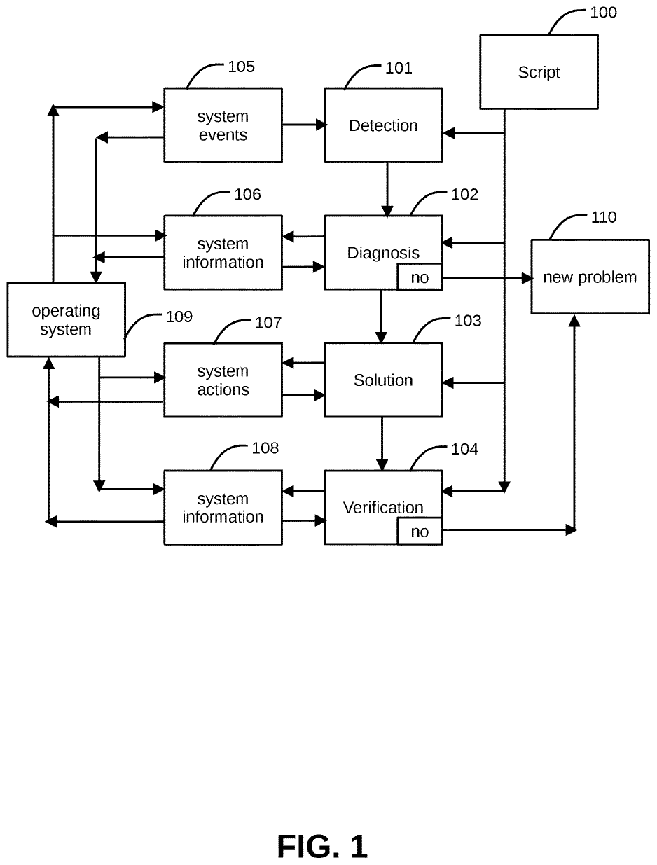

Turning to the drawings, FIG. 1 is a block diagram illustrating the automation pipeline and process flow, in accordance with some embodiments of the present invention. An automation script 100 can manage the operation of a detection module 101, a diagnosis module 102, a solution module 103, and a verification module 104. The operating system 109 of the device being supported can generate system events 105 that can be recognized by the detection module 101 as a potential indicator of an issue. The detection module 101 can pass this information to the diagnosis module 102 which can use system information 106 to make a more detailed diagnosis of a potential problem. The system information 106 may be collected from the operating system 109 on an ongoing basis, or it may be requested from the operating system 109 as the result of a request by the diagnosis module 102. The diagnosis module 102 may determine that its diagnosis criteria do not indicate a known problem, and as a result it may indicate the occurrence of a new problem 110 that may correspond to the system events 105 reported by the detection module 101. The diagnosis module 102 may instead determine that its criteria indicate a known problem with a solution and can pass this information to the solution module 103. The solution module 103 can implement the known solution to the problem by using system actions 107 that can be implemented by the operating system 109. This process may also involve feedback from the operating system 109 to the solution module 103 about the operation of the system actions 107. Once the solution module 103 is finished with implementing the known solution, it can pass this information to the verification module 104, which can use system information 108 from the operating system 109 to verify that the problem has been correctly resolved and is no longer affecting the end user. The system information 108 may be collected from the operating system 109 on an ongoing basis, or it may be requested from the operating system 109 as the result of a request by the verification module 104. If the verification module 104 discovers that the problem has not been resolved, then it may indicate the occurrence of a new problem 110 that may be a similar problem to the known problem detected by the detection module 101 and diagnosed by the diagnosis module 102, but one that is not resolved by the known solution applied by the solution module 103.

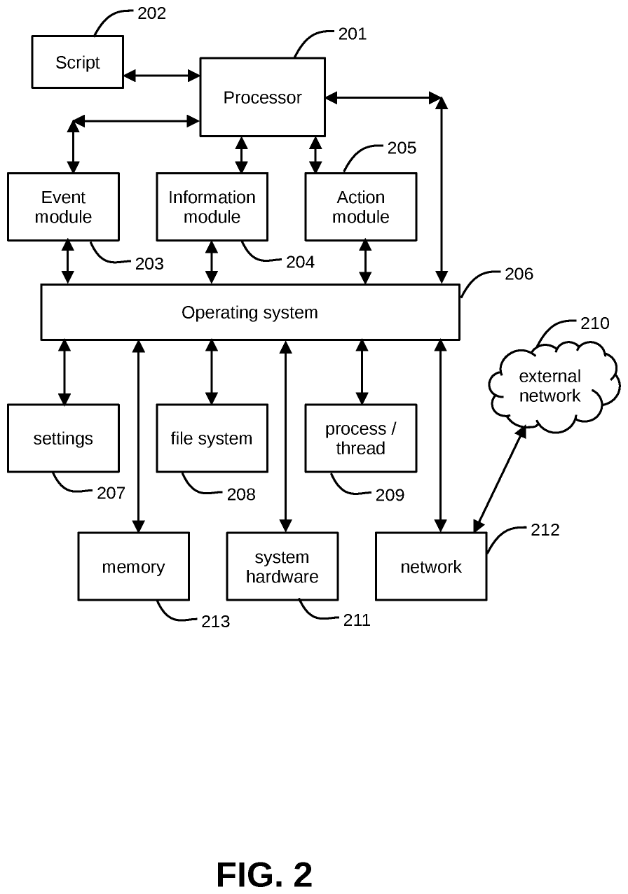

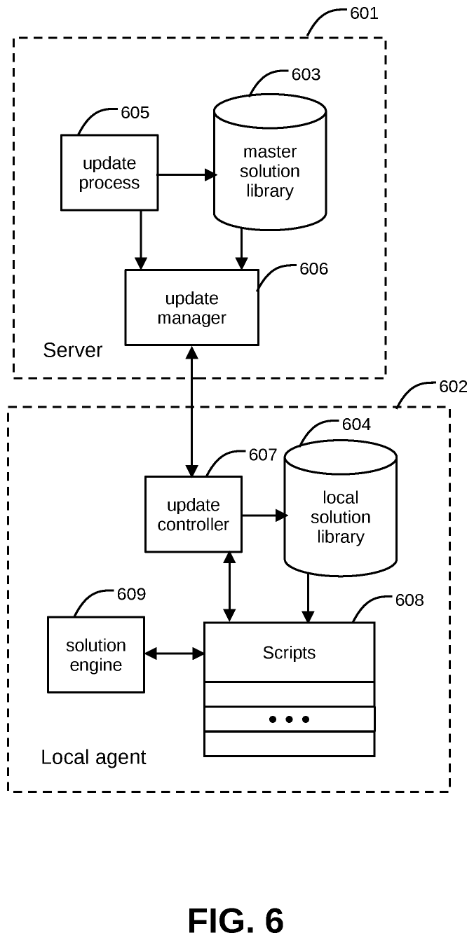

FIG. 2 is a block diagram illustrating the local agent solution architecture, in accordance with some embodiments of the present invention. A processor 201 on the device being supported can manage the operation of a script 202 that can be retrieved from a library as will be detailed later with respect to FIG. 6. The processor 201 can also manage the operation of the operating system 206. The operating system 206 can supervise the operation and utilization of the memory 213 of the device, the system hardware 211 of the device, the network interface 212 of the device, the file system 208 used by the device, and the process and thread system 209 that can be used to control the execution of code by the processor 201. The network interface 212 can be used by the operating system 206 to interface to an external network 210. The operating system 206 can also supervise the operation and utilization of a settings module 207 that can be used to control how the operating system 206 and applications run by the processor 201 operate. An example of a settings module may be a registry. The operating system 206 can be used by the processor 201 to inform and operate an event module 203, an information module 204, and an action module 205. The event module 203 can monitor and query activities in the settings module 207, memory 213, file system 208, system hardware 211, process/thread module 209, and network interface 212 through the operating system 206, as well as other operating system functions, and maintain a data and alerting interface used by the processor 201 to determine events that affect the operation of the supported device. The event module 203 may correspond to the management of the system events 105 depicted in FIG. 1. The information module 204 can monitor and query activities in the settings module 207, memory 213, file system 208, system hardware 211, process/thread module 209, and network interface 212 through the operating system 206, as well as other operating system functions, and maintain a data interface used by the processor 201 to determine information about the state of the supported device. The information module 204 may correspond to the management of the system information module 106 and the system information module 108 depicted in FIG. 1. The action module 205 can monitor and control activities in the settings module 207, memory 213, file system 208, system hardware 211, process/thread module 209, and network interface 212 through the operating system 206, as well as other operating system functions, and maintain a data and control interface used by the processor 201 to change the state of and initiate operations on the supported device. The action module 205 may correspond to the management of the system actions 107 depicted in FIG. 1.

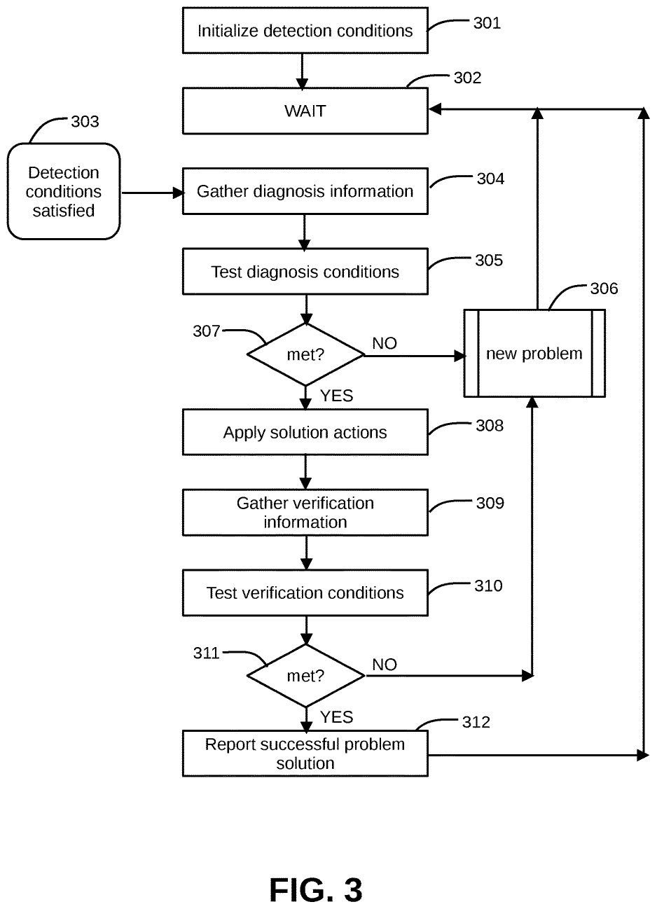

FIG. 3 is a flowchart illustrating the local agent solution process, in accordance with some embodiments of the present invention. Step 301 can initialize the conditions that may be detected to initiate a solution. Step 302 can then wait for those conditions. The local agent may go into a low-resource-utilization “sleep” mode while step 302 is waiting. Once the detection conditions are satisfied in step 303, step 304 can gather diagnosis information about the problem. Step 305 can further test the conditions of the supported device and step 307 can check whether or not the diagnosis conditions are met. If not, then step 306 can handle the situation as a new problem that has not yet been provided with a solution, and then can proceed to step 302 to wait for a further detection of conditions in step 303. If step 307 determines that the diagnosis conditions are met, it can proceed to step 308 which can apply the known solution for the problem. Step 309 can then gather information about the problem on the supported device to verify that the problem has been successfully resolved. Step 310 can test the verification conditions using the information from step 309, and step 311 can determine whether the problem can be verified as being successfully resolved. If step 311 determines that the problem has not been successfully resolved, then it can proceed to step 306 to handle the situation as a new problem that has not yet been provided with a solution. If step 311 determines that the problem has been successfully resolved, then it can proceed to step 312, which can report the successful problem solution. Both step 306 and step 312 can proceed to step 302 to wait for a further detection of conditions in step 303.

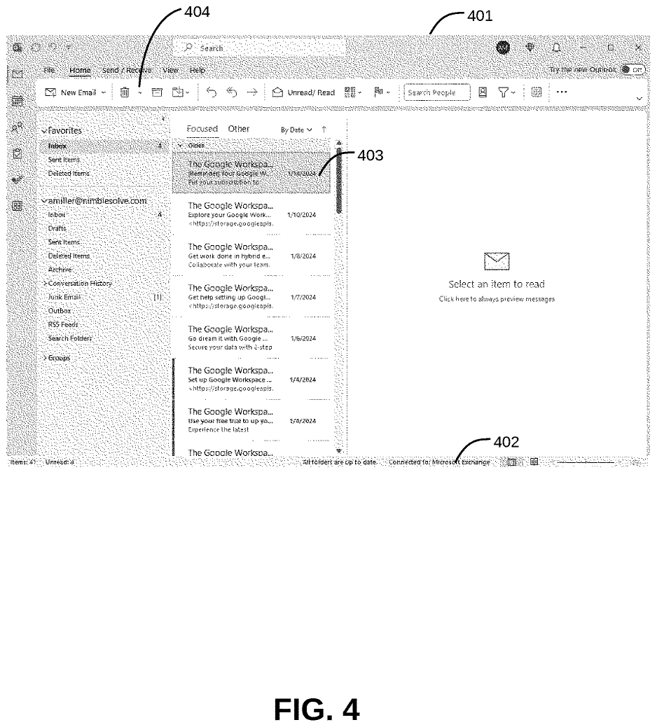

FIG. 4 is an illustration of the user interface of an application that has not yet encountered an example problem, in accordance with some embodiments of the present invention. User interface 401 can be an interface for a user to access an email application. The user can use commands in the toolbar 404 to operate and act on a selected email message 403. The user interface 401 can contain an indication 402 that the email application is currently connected to the email server and may therefore be able to send and receive messages and other configuration information and updates.

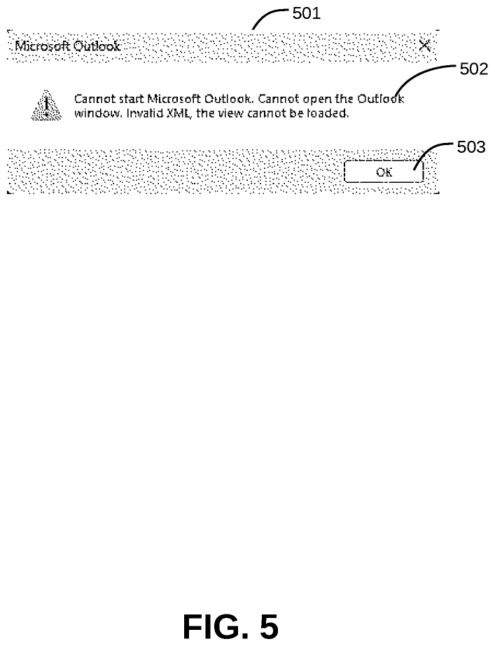

FIG. 5 is an illustration of the user interface of an application that has encountered an example problem, in accordance with some embodiments of the present invention. A configuration file of the email application depicted in FIG. 4 may become altered or corrupted in such a way that the email application may not be able to successfully read it. As a result, the user interface dialog 501 may be displayed when the email application is started by the end user, and a message 502 can indicate that the application is not able to start successfully. The end user may have no option other than to click on a button 503 to accept the notification. The end user may feel frustrated since little information and no options for resolution are provided. However, if the local agent depicted in FIG. 1 is operating on the device, then the processes depicted in FIG. 1 and FIG. 3 may be able to detect and resolve the issue, possibly by correcting the format of the corrupted configuration file, and then the end user may be able to successfully start and use the email application as depicted in FIG. 4, without the appearance of the error dialog 501.

FIG. 6 is a block diagram illustrating the script update architecture for solution scripts, in accordance with some embodiments of the present invention. The local agent 602 on the supported device can maintain a local solution library database 604 with a collection of scripts 608 that can contain the instructions used by the solution engine 609 for detecting, diagnosing, solving, and verifying problems on the supported device. Each script in the collection 608 may correspond to the script 100 depicted in FIG. 1. The solution engine 609 may correspond to the implementation the processes depicted in FIG. 1 and FIG. 3. A server 601 may maintain a master solution library 603 that can contain a set of scripts that may be the same scripts in the collection 608 or may be a different set of scripts. An update process 605 on the server 601 can use data from the database 603 to operate an update manager 606 to update the local agent 602 with any new or modified scripts in the database 603. The update manager 606 can communicate with an update controller 607 on the local agent to complete this update. The update manager 606 and update controller 607 can cooperate to determine which scripts in the local database 604 and collection 608 need to be updated from scripts in the master database 603, and then complete the updates of those scripts. It should be noted that there can be multiple instances of the local agent 602, on multiple supported devices, that can be supported by a single server 601. There can also be multiple instances of the server 601, which can have multiple instances of the master database 603 that can be synchronized by a database synchronization process (not pictured).

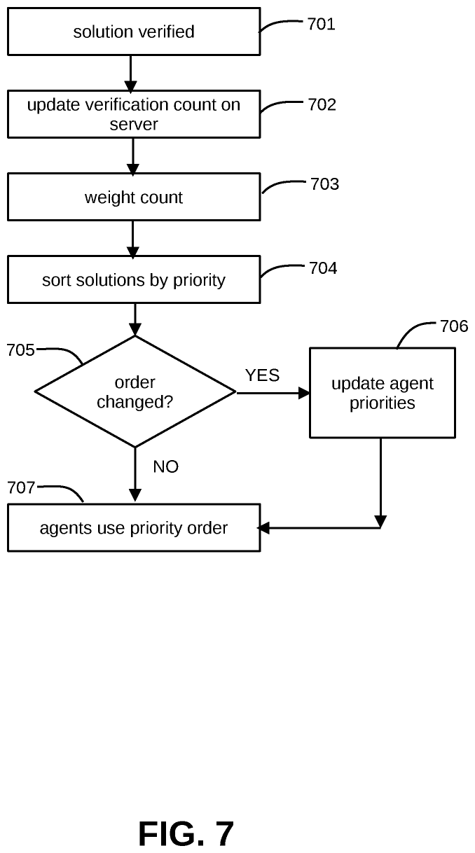

FIG. 7 is a flowchart illustrating the prioritization of automation scripts, in accordance with some embodiments of the present invention. The local agent may need a priority order of problem solutions. For example, the prioritization may select which solutions have their detection conditions initialized. Step 701 can start with a solution that has been successfully applied and verified. Step 702 can update a central count of successful verifications of that solution on a server. Step 703 can weight the count of successful verifications for that solution, and step 704 can sort the solutions by the weighted counts, providing a priority order. For example, the weight in step 703 may depend on a severity of the problem that is stored with the problem. Step 705 can check whether the sort in step 704 changed the priority order of the solutions. If so, step 705 can proceed to step 706 to update the priority order on the local agents and then proceed to step 707. If not, step 705 can proceed to step 707 to have the local agents use the existing priority order of the problem solutions. The process in step 706 to update the local agents may use the update architecture depicted in FIG. 6.

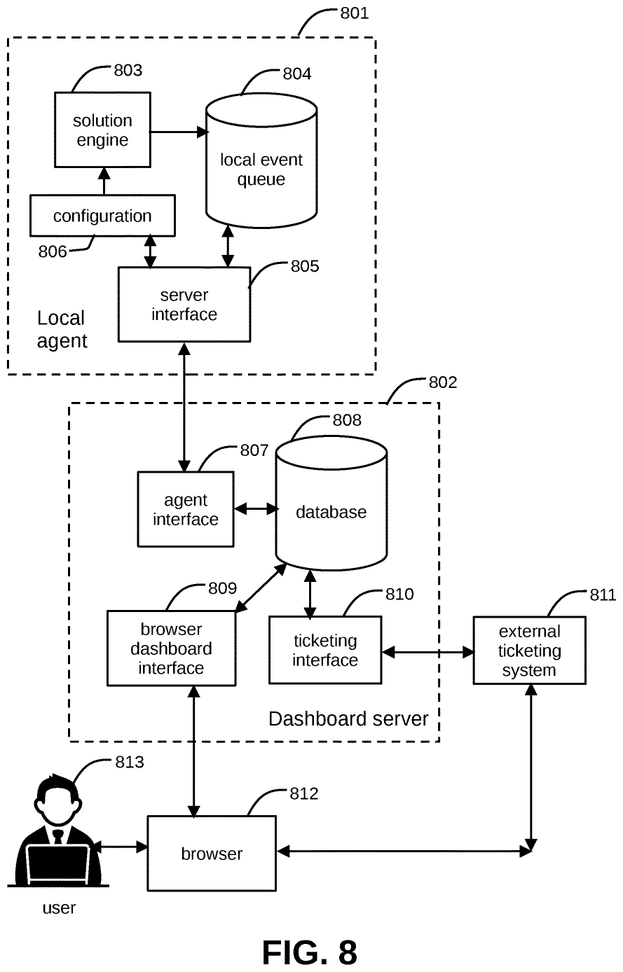

FIG. 8 is a block diagram illustrating the reporting and dashboard architecture for the local agent and dashboard server, in accordance with some embodiments of the present invention. Local agent 801 can have a solution engine 803 that can generate entries for a local event queue 804 that may be used to provide visibility for a user 813 to understand what actions the local agent 801 is taking. The solution engine 803 may use an architecture like the one depicted in FIG. 1. The local event queue 804 may store entries corresponding to those generated by step 306 and step 312 depicted in FIG. 3. The server interface 805 in the local agent 801 can communicate with an agent interface 807 in a dashboard server 802. The agent interface 807 can format and store entries coming from the local event queue 804 and store them in a database 808 used by the dashboard server 802. A browser dashboard interface 809 can use the database 808 to provide a user interface to the user 813 through a browser 812, which can help the user 813 to understand what actions the local agent 801 is taking. The user 813 may also have the ability to use the browser interface 809 through the browser 812 to update the database 808 with configuration commands for the local agent 801. These commands can be communicated from the database 808 through the agent interface 807 to the server interface 805, which can use the commands to update the configuration 806 in the local agent 801 that can be used to control aspects of the operation of the solution engine 803. The user 813 may also wish to use an external ticketing system 811, which may be accessed by the browser 812 through a browser interface of the ticketing system 811. The dashboard server 802 can use a ticketing interface 810 to utilize data from the database 808 to provide better integration between the operation of the dashboard server 802 and the external ticketing system 811. For example, the dashboard server can create tickets in the ticketing system 811 for problems detected by the solution engine 803, and then mark them appropriately depending on whether they were solved successfully or not.

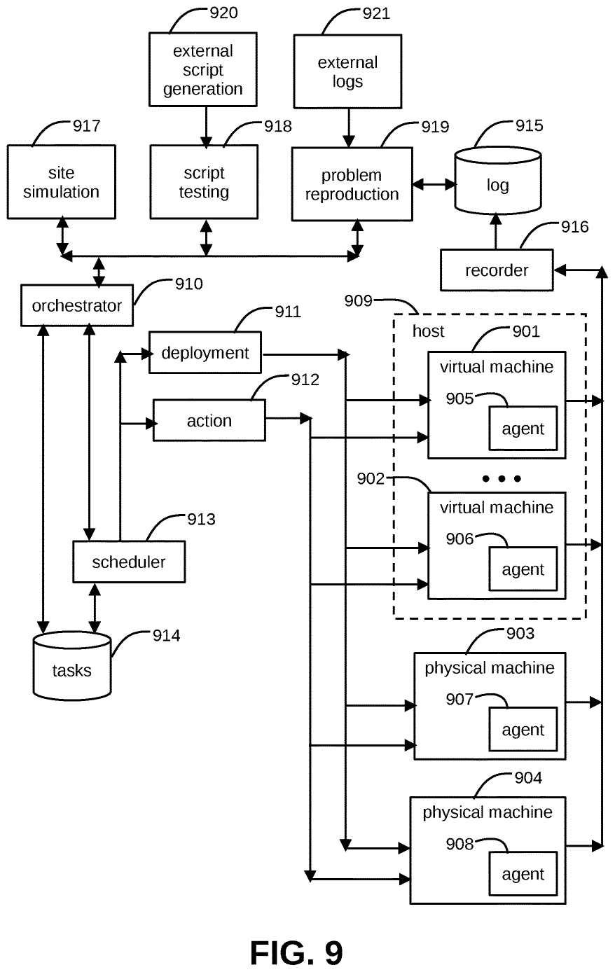

FIG. 9 is a block diagram illustrating the simulation engine architecture, in accordance with some embodiments of the present invention. The simulation engine can use a set of virtual machines 901-902 on a host 909 to run simulations. The simulation engine can also use a set of physical machines 903-904 to run simulations. The virtual machines 901-902 can include agents 905-906 and the physical machines 903-904 can include agents 907-908. The agents 905-908 can assist with the simulation and may be local agents as depicted in FIGS. 2 and 3. An orchestrator 910 may control the operation of the simulation engine and may manage a set of requests for site simulation 917, script testing 918, and problem reproduction 919 by using a scheduler 913 to organize tasks 914. The scheduler 913 may use a deployment module 911 to set up and configure the simulation machines 901-904, and may use an action module 912 to drive the simulations on the simulation machines 901-904. The deployment module 911 may use a container-based system for managing multiple configurations for the simulation machines. The tasks 914 and scheduler 913 may use a database (not pictured) for storage. The action module 912 may interact with the operating systems on the simulation machines 901-904 to cause actions simulating user inputs, external inputs, asynchronous events, and any other type of actions. A recorder 916 can record system event streams and other outputs from the simulation machines 901-904. The recorder 916 can record system events, display output, audio output, network activity, and any other type of outputs. The recorder 916 can add a time stamp to event entries and can write into a log database 915.

The site simulation 917 may be used to generate random or structured inputs, or both, to simulate the operation of a group of devices. This may be useful in exercising configurations used at a customer site to help anticipate problems that might arise. The site simulation 917 may be able to use the simulation engine to simulate this operation more quickly than actual users, and may also be able to cause a wider variety of actions than actual users, in order to uncover issues more rapidly. The recorder 916 can then provide an accurate record of the events leading to problems, which may allow them to be reproduced and addressed before they affect actual end users.

The problem reproduction 919 can use the log database 915 written by the recorder 916 to set up and reproduce the conditions leading to a problem, and may therefore provide a reliable way to reproduce the problem to allow further characterization and study in order to generate an automated solution for the problem. This process can be used in conjunction with the site simulation 917 described previously to address problems that are discovered during simulation before they are encountered by actual end users. This process can also use external logs 921 generated by actual supported devices in order to address problems that occurred on supported devices and affected actual end users.

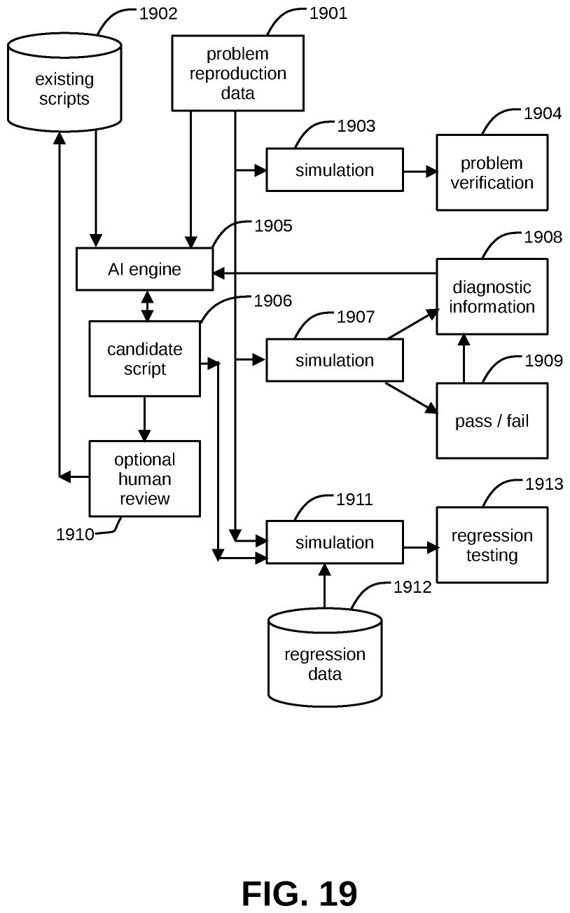

The script testing 918 can be used to automate the testing and validation of scripts from external script generation 920. The script testing 918 can use the orchestrator 910 in conjunction with the deployment module 911 to set up the agents 905-908 with a copy of the script to be tested. The script testing 918 can do validation testing by working in concert with the problem reproduction 919 to verify that the problem occurs when the script is not enabled, and the problem does not occur when the script is enabled. The script testing 918 can do regression testing by working in concert with the problem reproduction 919 to ensure that the script still correctly resolves the problem after some period of time. The script testing 918 can do platform testing by working in concert with the problem reproduction 919 to determine the devices and operating systems where the script correctly resolves the problem. The script testing 918 can do development testing by running the script and reporting any errors or other anomalies recorded by the recorder 916 back to the script developer. The external script generation 920 can be driven by a human script developer. It can also be driven by an automated script development process, or a partially automated script development process that can assist a human script developer, as will be described in further detail with reference to FIG. 19.

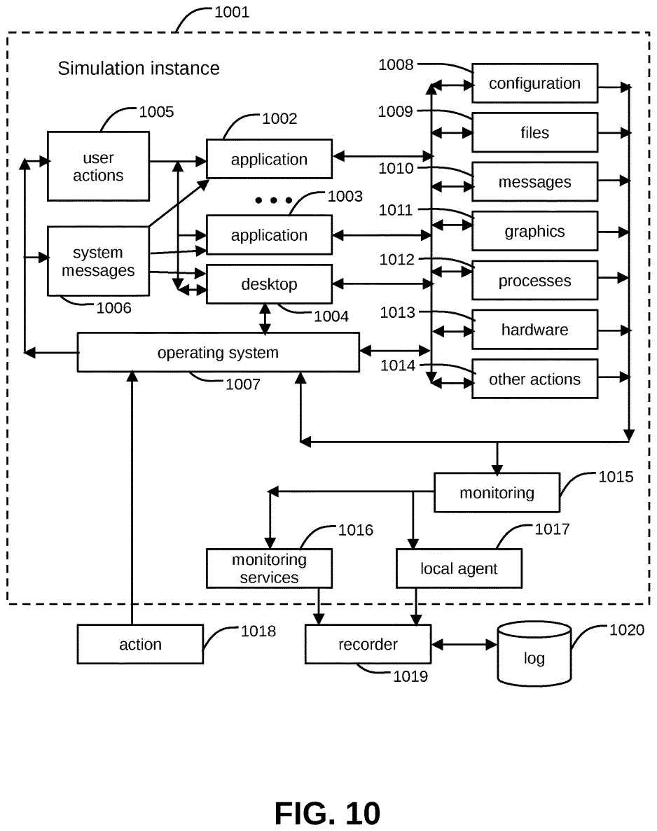

FIG. 10 is a block diagram illustrating the simulation data recording and action architecture for a simulation instance, in accordance with some embodiments of the present invention. The simulation instance 1001 can be used to run simulations as previously described. The simulation instance 1001 can run an operating system 1007 that can supervise the operation of the device and can manage the execution of applications 1002-1003. The operating system 1007 can also manage a desktop 1004 that can provide a user interface to aspects of the operating system 1007 and the applications 1002-1003. The operating system 1007 can manage user actions 1005 and system messages 1006 that can affect the desktop 1004 and the applications 1002-1003. The operating system 1007, applications 1002-1003, and desktop 1004 can all interact with a configuration interface 1008, files 1009, messages 1010, graphics 1011, processes 1012, hardware 1013, and other actions 1014, all of which may affect the state and operation of the simulation instance 1001, the operating system 1007, and external interfaces (not pictured). A monitoring module 1015 can detect all activity of the configuration interface 1008, files 1009, messages 1010, graphics 1011, processes 1012, hardware 1013, and other actions 1014 and pass this information along to the local agent 1017 and a set of monitoring services 1016. The monitoring services 1016 and local agent 1017 may use a recorder 1019 to record the activity and save it in a log 1020.

The simulation instance 1001 may correspond to a simulation machine 901-904 as depicted in FIG. 9. The recorder 1019 may correspond to the recorder 916 as depicted in FIG. 9. The log 1020 may correspond to the log 915 as depicted in FIG. 9. The action module 1018 may correspond to the action module 912 as depicted in FIG. 9. The local agent 1017 may correspond to a local agent as depicted in FIGS. 2 and 3.

In a supported device of an end user, the user actions 1005 and desktop 1004 may be used to interact with the end user and allow them to control the device. This can also be the case in a simulation instance 1001, but in order to support the simulation engine operation as previously described, an action module 1018 may be able to use the operating system to control the user actions 1005, system messages 1006, and desktop 1004 directly without the participation of an end user.

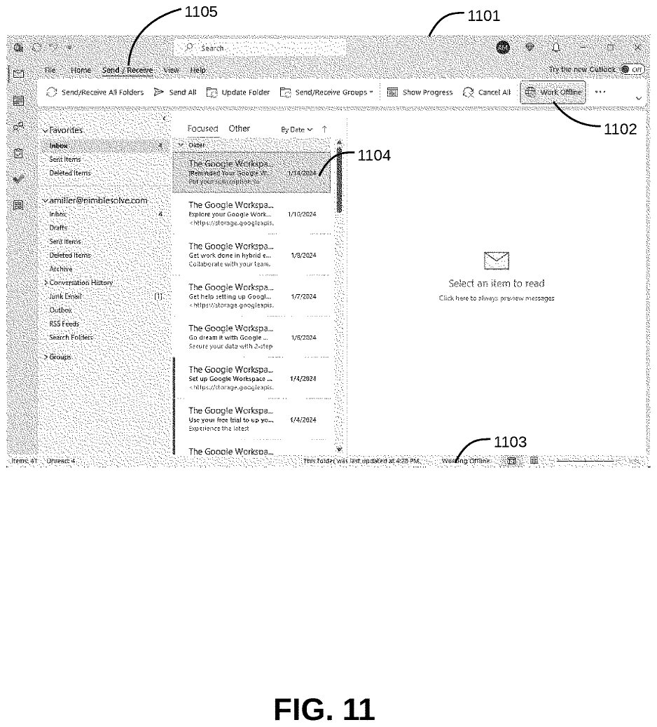

FIG. 11 is an illustration of the user interface of an application that is about to encounter an example problem with no automated solution, in accordance with some embodiments of the present invention. An email application can have a user interface 1101 that allows an end user to select and operate on a message 1104. The user may be able to select a “Send/Receive” menu item 1105 to control messaging options. The user may be able to turn on a “Work Offline” messaging option 1102 that can allow the user to read and compose email messages but will not attempt to contact the email server to fetch new messages or send messages composed by the user. The user interface may indicate the offline mode by highlighting the “Work Offline” control 1102 and indicating in a small status indicator 1103 that the application is working offline. An end user might choose the offline mode, for example, while on an airline flight without network access, to avoid being bothered by repeated messages that the network is not available. When the end user finishes the flight and returns to an environment with network access, the end user may disable the offline mode, which can cause the email application to connect to the email server to fetch messages that have arrived in the meantime and send messages that the user has composed while in offline mode.

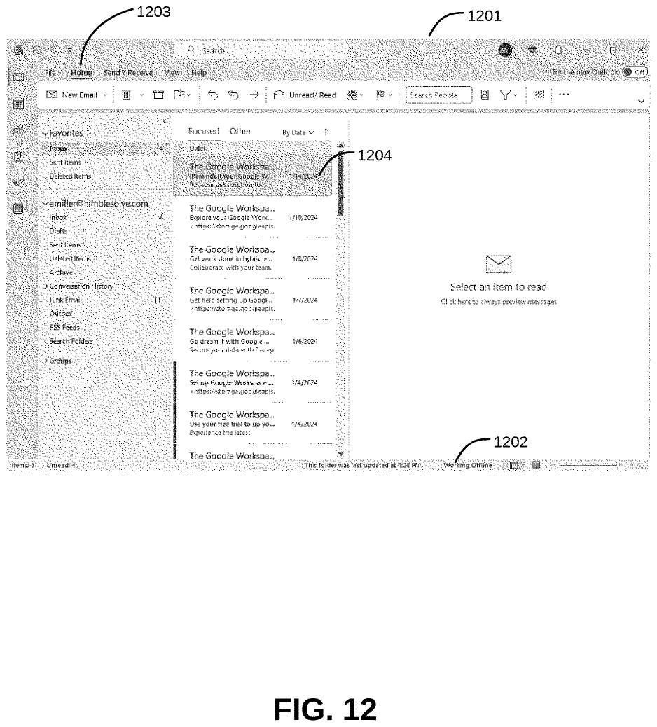

FIG. 12 is an illustration of the user interface of an application that is encountering an example problem with no automated solution, in accordance with some embodiments of the present invention. The user interface 1201 of the same email application depicted in FIG. 11 can be displayed when the application is started by the end user. However, the application may start with the “Home” menu 1203 selected, so the only visible indication that the application is in offline mode may be the small status message 1202 indicating “Working Offline.” The end user may forget that the application is in offline mode, and not understand why messages 1204 are not being sent and received. The end user may become frustrated and this problem may become a support issue.

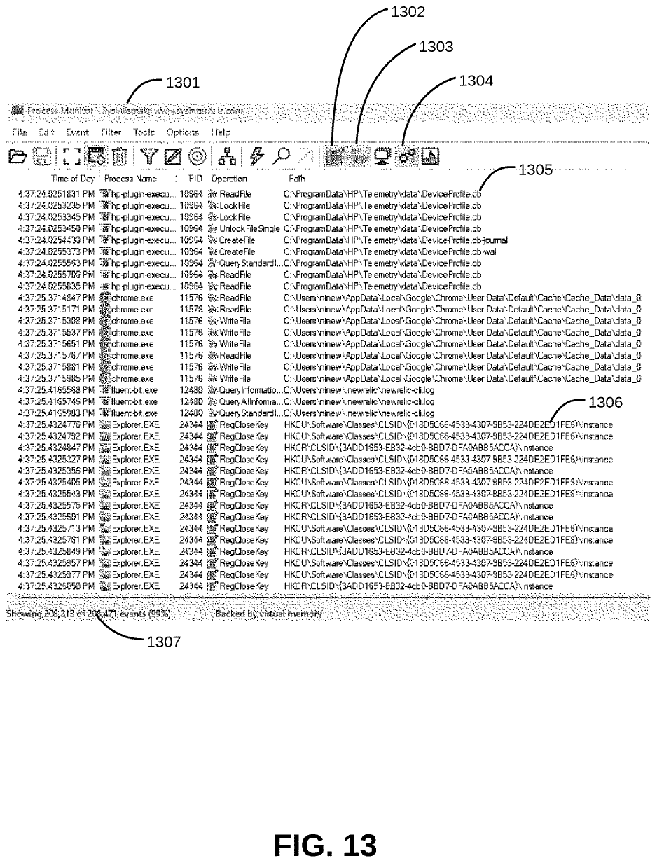

FIG. 13 is an illustration of an example system event stream, in accordance with some embodiments of the present invention. A neural network may be used to recognize problems for which the local agent depicted in FIGS. 2 and 3 has no solution. The neural network may be a binary classifier, multi-valued classifier, perceptron, deep learning model, feed-forward network, recurrent network, modular network, radial basis function network, liquid state machine, residual network, transformer network, convolutional network, long short-term memory network, adversarial network, autoencoder, sequence learning model, capsule network, or any other type of neural network. The neural network may be trained to recognize the incidence of a problem using the presence of an error dialog, error message, error log, audible warning, system fault, application fault, unexpected application exit, ticket submission, repeated end user behavior, or any other indicator of a problem. The features used as input to the neural network may include a system event stream 1301. The system event stream capture may be enabled to capture registry events 1302, file system events 1303, and process/thread events 1304, as well as any other type of system events. A file system event 1305 may be captured, as well as a registry event 1306. A large number of events 1307 may be captured, and all or some of the events may be used as training data for the neural network.

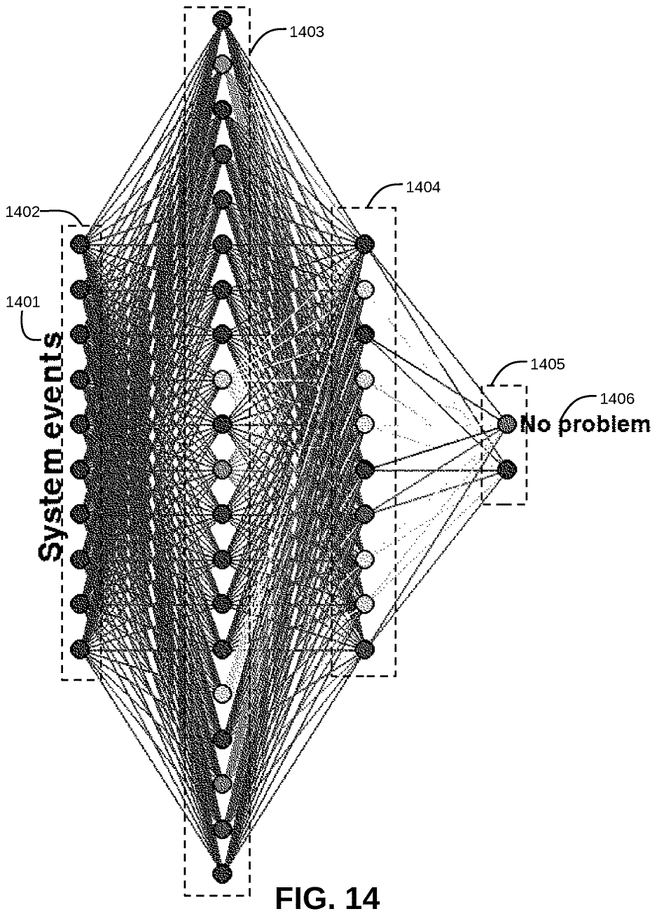

FIG. 14 is a block diagram illustrating a neural network evaluating a system event stream on a device that is not encountering a problem, in accordance with some embodiments of the present invention. The neural network previously described for recognizing problems may be a binary classifier with a binary output stage 1405, two hidden layers 1403-1404, and an input layer 1402. The input layer 1402 may be connected to an event stream 1401. The event stream 1401 may correspond to the event stream depicted in FIG. 13. The neural network may arrive at a classification 1406 of “No problem” based on the training of the neurons and the system event stream 1401 present at the input layer 1402.

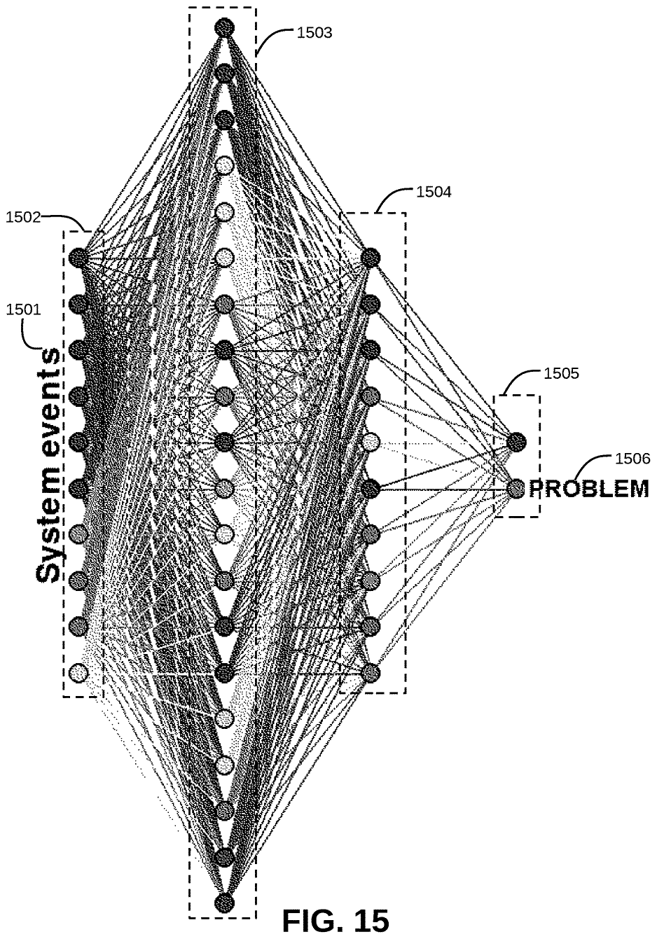

FIG. 15 is a block diagram illustrating a neural network evaluating a system event stream on a device that is encountering a problem, in accordance with some embodiments of the present invention. The neural network depicted in FIG. 15 may correspond to the neural network depicted in FIG. 14. The neural network previously described for recognizing problems may be a binary classifier with a binary output stage 1505, two hidden layers 1503-1504, and an input layer 1502. The input layer 1502 may be connected to an event stream 1501. The event stream 1501 may correspond to the event stream depicted in FIG. 13. The neural network may arrive at a classification 1506 of “PROBLEM” based on the training of the neurons and the system event stream 1501 present at the input layer 1502.

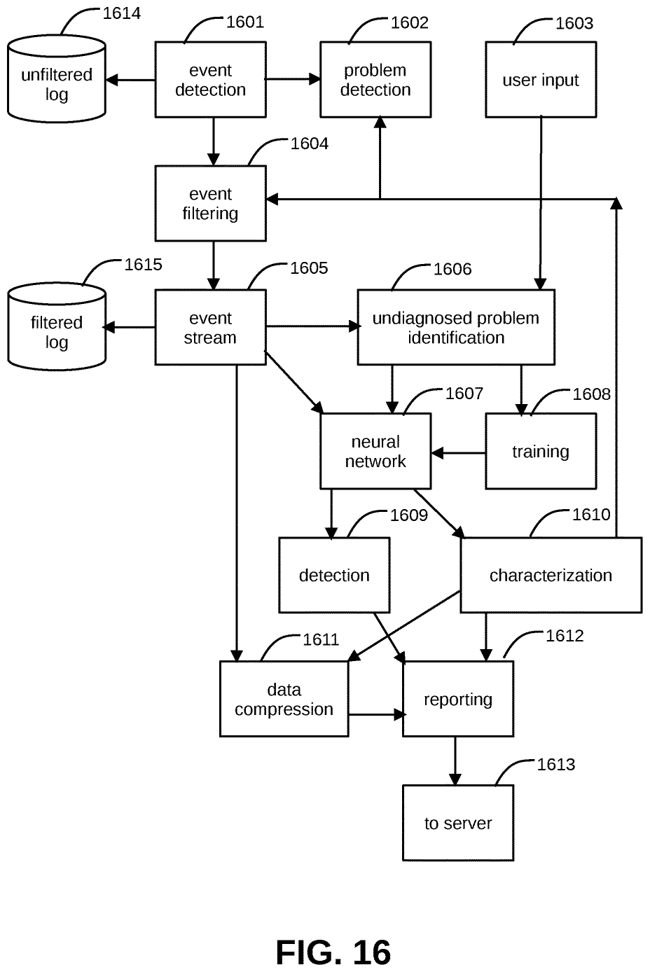

FIG. 16 is a block diagram illustrating the local agent architecture for recording, compressing, and transmitting system event stream to a server, in accordance with some embodiments of the present invention. The event detection module 1601 can detect system events and can use the events to trigger problem detection 1602. The event detection module 1601 can also save all detected events in an unfiltered log 1614, and can use event filtering 1604 to generate a filtered event stream 1605 which may be saved in a filtered log 1615. The problem detection module 1602 can generate an indication of an undiagnosed problem 1606, which may be a new problem that has no detection or diagnosis associated with it. User input 1603 may also generate an indication of an undiagnosed problem 1606, for example, if an end user submits a ticket. The filtered event stream 1605 may also generate an indication of an undiagnosed problem 1606, for example, if an error dialog is created. The filtered event stream 1605 and indicators of undiagnosed problems 1606 can be combined to make training data 1608 for a neural network 1607 that can be trained to detect 1609 and characterize 1610 problems for which no automated solution has previously been created. The characterization 1610 of the problem, which may include statistics or classes of system events associated with the problem or groups of similar problems, can be used to modify the event filtering 1604 and the problem detection module 1602. Additionally, the characterization 1610 can be used to guide a data compression module 1611 that reduces the size of the filtered event stream 1605 in preparation to transmit it 1613 to a server. The detection 1609 of a new problem can be used to signal a reporting module 1612 to format the compressed event log from the data compression module 1611 and transmit it 1613 to the server. Since the characterization 1610 can recognize repeated patterns that are common to the incidence of problems, and the patterns may be lengthy, the compression ratio that the data compression module 1611 achieves may be large, enabling the efficient transmission of event streams associated with unsolved problems.

The event detection 1601 may correspond to the event stream depicted in FIG. 13. The undiagnosed problem identification 1606 may correspond to the processing in step 306 depicted in FIG. 3. The neural network 1607 may correspond to the neural networks depicted in FIGS. 14 and 15.

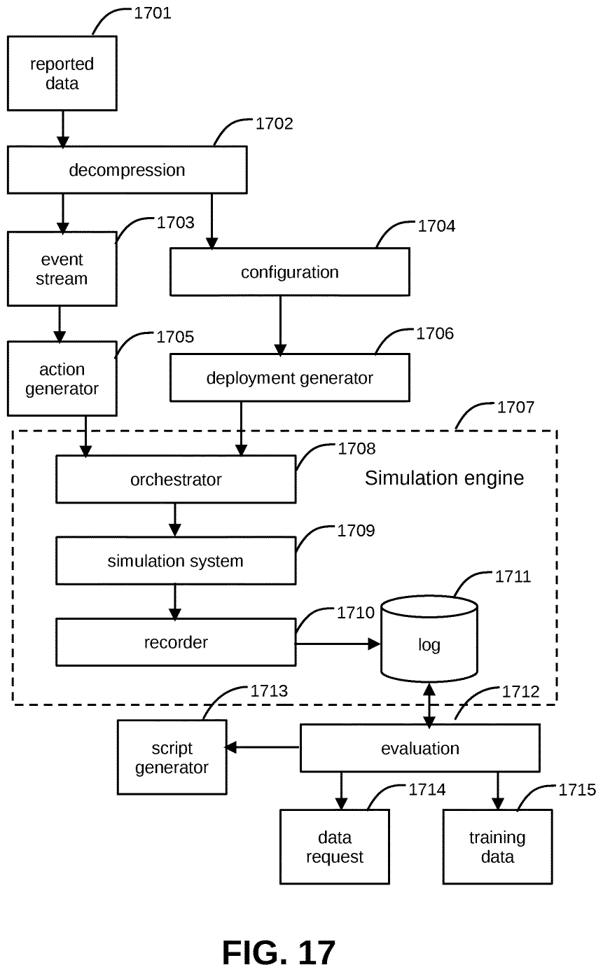

FIG. 17 is a block diagram illustrating the simulation engine architecture for receiving and processing system event stream data, in accordance with some embodiments of the present invention. The compressed event stream depicted in FIG. 16 can be reported 1701 to a server and may be decompressed by a decompression module 1702 into the original filtered event stream 1703 and configuration data 1704 associated with the supported device where the data 1701 originated. The configuration data 1704 can be used to generate deployment instructions 1706 for deploying a simulation system to duplicate the relevant aspects of the supported device where the data 1701 originated, and the event stream 1703 can be used to generate action instructions 1705 for reproducing the unsolved problem that was detected. The action instructions 1705 and deployment instructions 1706 can be sent to the simulation engine 1707 where the orchestrator 1708 can supervise using a simulation system 1709 to attempt to reproduce the unsolved problem that was detected, by reproducing both the configuration of the device and the events that led to the problem. A recorder 1710 can record the result of the simulation and save it in a log 1711. An evaluation module 1712 can determine whether the problem was successfully reproduced, and if so, may send this information to a script generator 1713 to generate a script for automating the solution of the problem. If the evaluation module 1712 determines that the problem was not successfully reproduced, then it may generate a request 1714 for more data from the supported device, and it may also generate additional training data 1715 that can be used to improve the neural network used to filter and compress the event stream on the supported device.

The reported data 1701 may correspond to data 1613 depicted in FIG. 16. The simulation engine 1707 may correspond to the simulation engine depicted in FIG. 9. The simulation system 1709 may correspond to the simulation instance 1001 in FIG. 10. The recorder 1710 may correspond to the recorder 916 depicted in FIG. 9 and the recorder 1019 depicted in FIG. 10. The log 1711 may correspond to the log 915 depicted in FIG. 9 and the log 1020 depicted in FIG. 10.

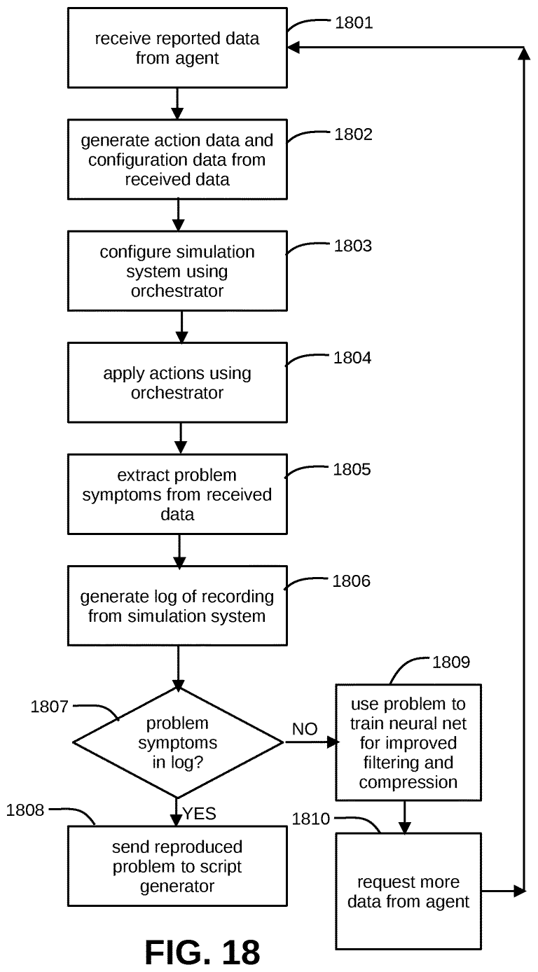

FIG. 18 is a flowchart illustrating the process of receiving and processing event stream data from the local agent at the simulation engine, in accordance with some embodiments of the present invention. In step 1801, the event stream data reported by a local agent can be received. In step 1802, the received data can be decompressed and used to generate action data in the form of action instructions and configuration data in the form of deployment instructions. These instructions can be sent to the orchestrator in the simulation engine. In step 1803, the orchestrator can use the deployment instructions to configure a simulation instance to match the supported device where the event stream originated, and in step 1804, the orchestrator can use the action instructions to reproduce the steps leading to the problem on the simulation instance. In step 1805, the event stream and the conditions that led to the indication of a problem can be extracted from the received data and used to create a set of problem symptoms. In step 1806, the simulation instance can generate a log of activity on the simulation instance in reproducing the problem. In step 1807, the log can be checked to see if the generated problem symptoms appear. If so, then in step 1808, information including at least the log, the symptoms, the configuration data, and the action data can be sent to the script generator. If not, then this may be an indication that insufficient data was received from the supported system in order to reproduce the problem correctly, so in step 1809, this information may be added to the training data for the neural networks used for filtering and compressing the event stream, and those neural networks may be re-trained. In step 1810, additional data may be requested from the local agent on the supported system, and the process can restart at step 1801 to try to reproduce the problem with the additional data requested in step 1810.

FIG. 19 is a block diagram illustrating the architecture for generating a script to solve a previously unsolved problem, in accordance with some embodiments of the present invention. The data 1901 for reproducing a problem can be sent to the simulation engine which can use a simulation instance 1903 which can verify 1904 that the problem can be reproduced. The data 1901 can also be sent to the artificial intelligence (AI) engine 1905 which can use the existing scripts 1902 and the problem reproduction data 1901 to generate a candidate script 1906 that may solve the problem represented by the data 1901. The candidate script 1906 can be used on a simulation instance 1907 to test whether or not it actually solves the problem represented by the data 1901. The simulation instance 1907 can indicate the result with a pass/fail indication 1909, and can also provide diagnostic information 1908 about why the script failed to solve the problem. The diagnostic information 1908 may include error dialogs, error messages, error logs, audible warnings, system faults, application faults, unexpected application exits, or any other indicators of a problem. The diagnostic information 1908 can be sent to the AI engine 1905, which may use it along with the candidate script 1906 and the existing scripts 1905 to update the candidate script 1906, which may make it more likely to solve the problem. The updated candidate script 1906 can then be re-tested by the simulation instance 1907 and the process repeated. This repeated incremental modification of the candidate script 1906 in an attempt to arrive at a version that solves the problem may be considered to be a generative adversarial network (GAN), where the AI engine 1905 is the generator and the simulation instance 1907 is the discriminator. The AI engine 1905 can be a large language model (LLM) generative predictive transformer (GPT) network, but it may also incorporate binary classifiers, multi-valued classifiers, perceptrons, deep learning models, feed-forward networks, recurrent networks, modular networks, radial basis function networks, liquid state machines, residual networks, convolutional networks, long short-term memory networks, autoencoders, sequence learning models, capsule networks, or any other type of machine learning implementation.

Once the candidate script 1906 is verified by the simulation instance 1907 to solve the problem represented by the data 1901, then the simulation engine can use a simulation instance 1911 to test the script 1906 against regression data 1912 with other known problems to make sure that the script 1906 does not have any negative interactions with other scripts or problems. When testing is finished on the script 1906, it can be optionally reviewed 1910 by a person, and can be incorporated into the database 1902 of existing scripts.

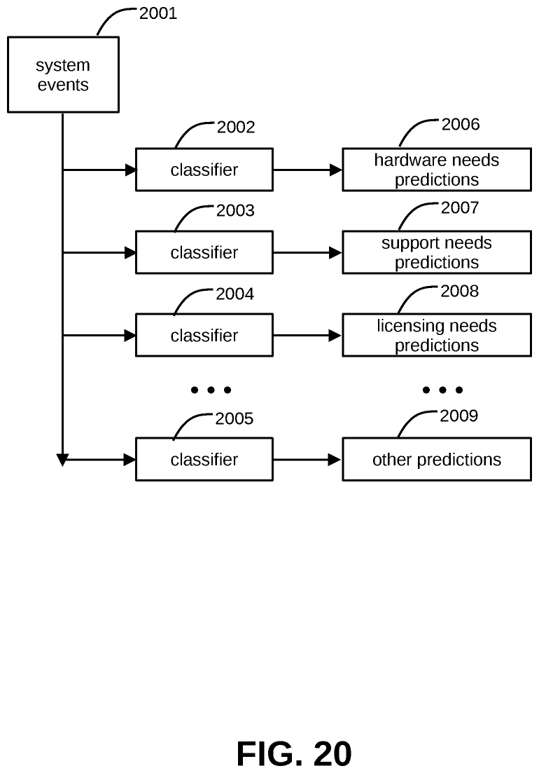

FIG. 20 is a block diagram illustrating the predictive analytics architecture for predicting support needs, in accordance with some embodiments of the present invention. A system event stream 2001 can be used as input to classifiers 2002-2005. The system event stream 2001 may correspond to the event stream depicted in FIG. 13. Using the system event stream 2001, classifier 2002 may generate predictions 2006 for upcoming hardware needs, classifier 2003 may generate predictions 2007 for upcoming support needs, classifier 2004 may generate predictions 2008 for upcoming licensing needs, and classifier 2005 may generate other types of predictions 2009 for upcoming needs. Predictions 2006 for upcoming hardware needs may be useful in ordering parts in advance to negotiate better pricing. Predictions 2007 for upcoming support needs may be useful in advertising open employment positions to hire appropriate staff to prepare. Predictions 2008 for upcoming licensing needs may be useful for buying bulk licenses at a discount. Classifiers 2002-2005 can be multi-valued classifiers, but may also incorporate binary classifiers, perceptrons, deep learning models, feed-forward networks, recurrent networks, modular networks, radial basis function networks, liquid state machines, residual networks, convolutional networks, long short-term memory networks, autoencoders, sequence learning models, capsule networks, or any other type of machine learning implementation.

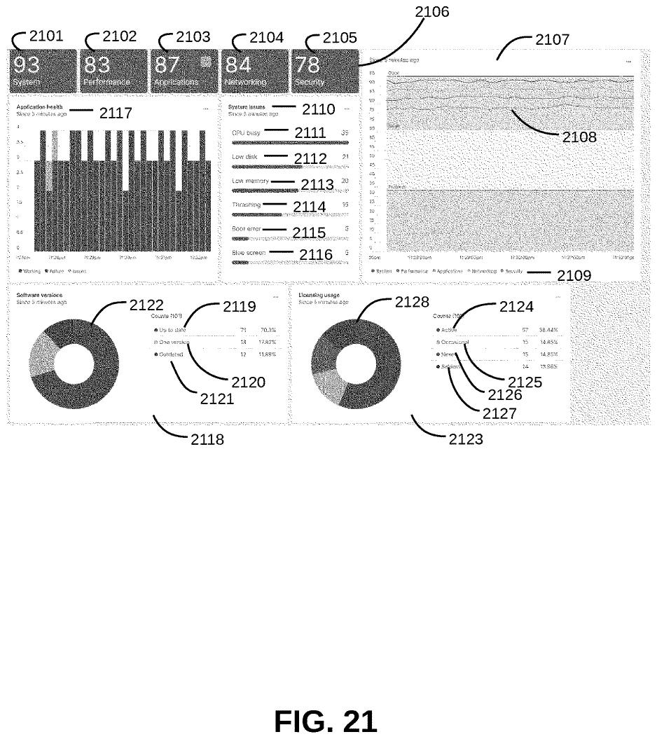

FIG. 21 is an illustration of the user interface of a dashboard displaying device information based on end user devices that are not encountering significant support issues, in accordance with some embodiments of the present invention. The line 2106 of overview scores 2101-2105 can give the user a quick overview of how well the end user devices are operating by indicating a score from 0 to 100 for each category. The System score 2101 can indicate how well the operating system is working on the devices, for example, how often a system fault (“blue screen”) occurs. The Performance score 2102 can indicate how well the devices are responding to end user requests, for example, how often the processor utilization is at 100%, forcing the end user to wait, or how much time the virtual memory system spends paging, forcing applications to wait. The Applications score 2103 can indicate how well user applications are working on the devices, for example, how often applications exit unexpectedly with a fault. The Networking score 2104 can indicate how well the network interface is working on the devices, for example, how often the device is offline because the network is unavailable, or how often the device is waiting for a network response before an application can proceed. The Security score 2105 can indicate how vulnerable the devices are to compromise, for example, how many of the devices have a known unpatched vulnerability that could be exploited in the device's current configuration. The score graph 2107 can show the values of the overview scores 2106 over time. The line graphs 2108 can plot the values of the five scores 2101-2105 as a function of time using colors that can be described by the legend 2109. This may provide the user with insight into issues that are happening on end user devices and what they are generally related to.

The Application Health graph 2117 may show a graph of how well applications are working on the devices over time, for example, how many of the applications are operating correctly versus those that have non-fatal issues and those that have failed. The data shown in the Applications Health graph 2117 may affect the Applications score 2103.

The System Issues table 2110 may show a histogram of what sorts of issues are affecting the devices, which may include, for example, a CPU Busy condition 2111, which may indicate how often a device's processor was too busy to service all requests, a Low Disk condition 2112, which may indicate how often a device had to take time to purge older files to free space for temporary storage, a Low Memory condition 2113, which may indicate how often a device had to page active memory out to storage to make room for applications needing physical memory to run, a Thrashing condition 2114, which may indicate how often a device encountered a condition where two actively running processors were trying to use the same physical memory and caused the memory manager to spend a large amount of time transferring their memory to and from storage, a Boot Error condition 2115, which may indicate how often a device was not successful at starting the operating system and required a retry to run, and a Blue Screen condition 2116, which may indicate how often a device encountered a fatal processor fault while running the operating system. The data shown in the System Issues table 2110 may affect the System score 2101 and the Performance score 2102.

The Software Versions plot 2118 can show an overview graph of the status of application software updates on the supported devices. The applications on the devices can be rated as being Up To Date 2119, which may indicate that the current version of the application is installed, One Version 2120, which may indicate that the application is slightly out of date but only needs one update to bring it up to date, or Outdated 2121, which may indicate that the application is more than one version behind. The summary for all applications on all devices may be shown in a pie chart 2122. The Licensing Usage plot 2123 can show the status of licensed application usage and may help in saving money by reallocating software licenses to end users who are using them actively, and applications that are being actively used. The data may show that applications are Active 2124, which may indicate that the applications are used frequently, Occasional 2125, which may indicate that the applications are used less frequently and may be a candidate for floating licenses, Seldom 2127, which may indicate that the applications are only used from time to time and may not be needed by the associated device users, and Never 2126, which may indicate that the applications are not used at all and are not needed by the associated device users. The summary for all licensing on all devices may be shown in a pie chart 2128.

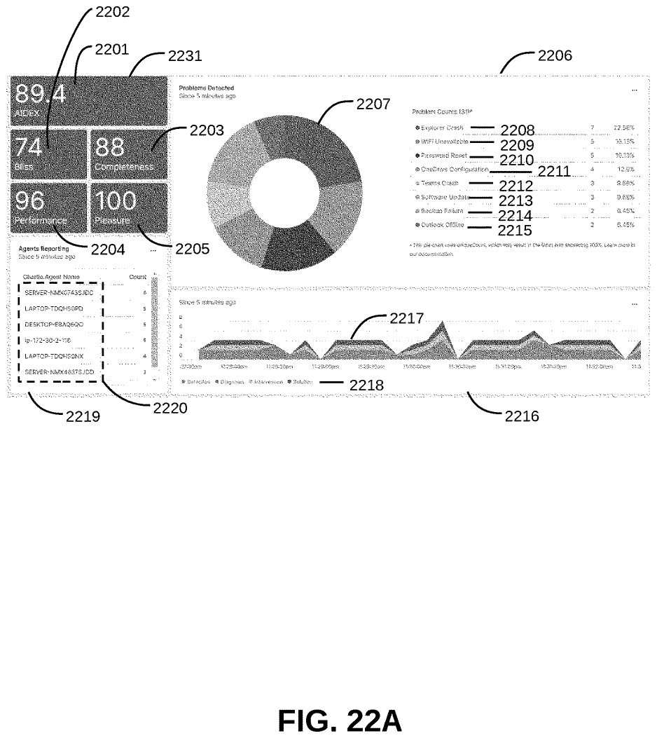

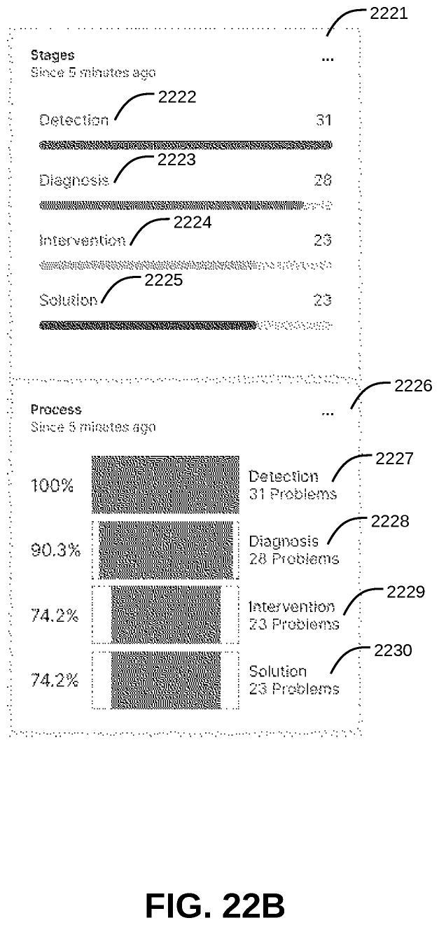

FIGS. 22A and 22B are illustrations of the user interface of a dashboard displaying support automation information based on end user devices that are not encountering significant support issues, in accordance with some embodiments of the present invention. In FIG. 22A, the section 2231 of overview scores 2201-2205 can give the user a quick overview of the effectiveness of support automation for end user devices by indicating a score from 0 to 100 for each category. The Bliss score 2202 can indicate how often a specific issue was avoided that definitely would have affected an end user, which may be how many times an automated solution was applied and verified to have solved a detected and diagnosed problem. The Completeness score 2203 can indicate how many different types of issues have been avoided that definitely would have affected an end user, which may be how many distinct automation scripts have run through to verification. The Pleasure score 2205 may indicate how many support tickets submitted by end users have been resolved with the help of support automation, which may be how many unknown problems were detected as the result of ticket submission that were later addressed by a script developed as the result of the detection. The Performance score 2204 may correspond to the Performance score 2102 depicted in FIG. 21. The Artificial Intelligence Device Experience (AIDEX) score 2201 may indicate an overall score that is derived from the values of the other scores 2202-2205.

The Problems Detected display 2206 can give a more detailed breakdown of the type and frequency of issues being addressed by support automation solutions. The solved issues can be listed in tabular form, for example, the Explorer Crash solution 2208, which may show how often a condition was corrected that was causing Explorer to fail to start, the Wi-Fi Unavailable solution 2209, which may show how often a configuration issue was corrected that was preventing Wi-Fi network access from working, the Password Reset solution 2210, which may show how often an automated solution was available to assist an authenticated user with the situation of having forgotten a password, the OneDrive Configuration solution 2211, which may show how often a setup issue was corrected that was preventing local files from syncing with cloud storage, the Teams Crash solution 2212, which may show how often a condition was corrected that was causing Teams to fail to start, the Software Update solution 2213, which may show how often an issue was corrected that was preventing a software update from installing properly, the Backup Failure solution 2214, which may show how often a configuration or connectivity issue was preventing a file backup from completing successfully, and the Outlook Offline solution 2215, which may show how often a user would have potentially been confused by Outlook being left in an offline state. The Outlook Offline solution 2215 may correspond to the example with respect to FIGS. 11 and 12. The pie chart 2207 can show the relative numbers of the solutions 2208-2215 and may help in visualizing the comparative frequency of the issues being addressed with support automation.

Turning to FIG. 22B, the Stages chart 2221 can provide a histogram of all support automation solutions that have been run and how far they proceeded, either through Detection 2222, which may indicate that the initial conditions indicating a possible problem were detected, Diagnosis 2223, which may indicate that a further detailed diagnosis confirmed that the problem was present, Intervention 2224, which may indicate that the solution was applied to attempt to solve the problem, or Solution 2225, which may indicate that the solution was verified to have solved the problem. The Process chart 2226 can display the same information as the Stages chart 2221, but as a funnel diagram indicating how the support automation proceeds from stage to stage, going from Detection 2227 to Diagnosis 2228 to Intervention 2229 to Solution 2230. The stages 2222-2225 in the Stages chart 2221, and the stages 2227-2230 in the Process chart 2226, may correspond to the stages 101-104 depicted in FIG. 1.

Turning back to FIG. 22A, the solution graph 2216 can show the activity of the support automation solutions 2117 over time, with the number of solutions on the y axis and time on the x axis, and the shadings of the data representing the stages through which the solution proceeded, as indicated by the legend 2218. The stages in the legend 2218 may correspond to the stages 2222-2225 in the Stages chart 2221 and the stages 2227-2230 in the Process chart 2226. The Agents Reporting table 2219 can show which end user systems 2220 are providing data for the dashboard.

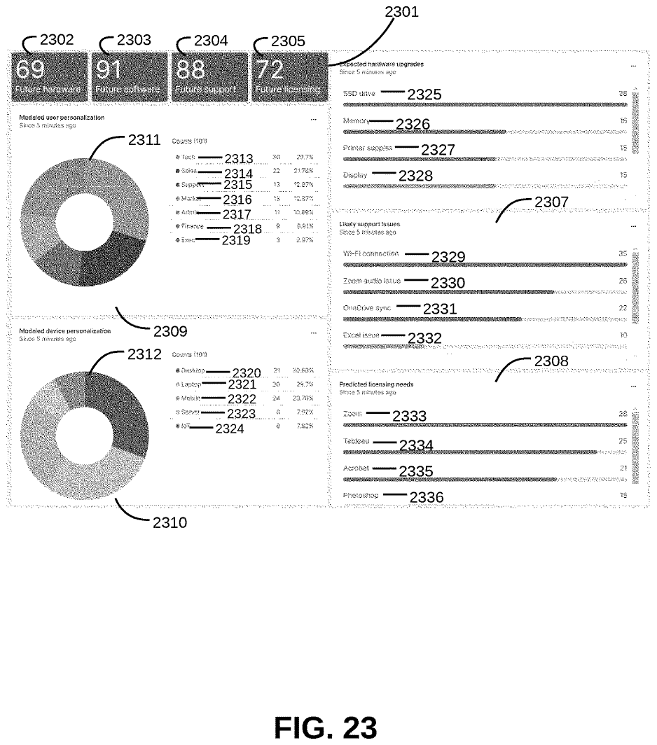

FIG. 23 is an illustration of the user interface of a dashboard displaying predictions for support needs based on end user devices that are not encountering significant support issues, in accordance with some embodiments of the present invention. The section 2301 of prediction scores 2302-2305 can give the user a quick overview of areas expected to require attention for end user devices in the future by indicating a score from 0 to 100 for each category. The Future Hardware score 2302 can indicate the likelihood of upcoming hardware issues on supported devices requiring attention, which may be helpful in planning ordering and inventory to take advantage of discounts available with larger future orders. The Future Software score 2303 can indicate the likelihood of upcoming software upgrade requirements on supported devices, which may be helpful in planning upgrade rollouts to minimize the impact on computing and network resources, and also reduce the negative impact from a faulty update. The Future Support score 2304 can indicate the likelihood of upcoming support issues on supported devices, which may be helpful in planning support staffing needs and hiring efforts. The Future Licensing score 2305 can indicate the likelihood of changes in software licensing requirements on supported devices, which may be helpful in negotiating volume discounts for licenses without over-purchasing. The predictive scores 2302-2305 may correspond to the predictions 2006-2009 depicted in FIG. 20.

The Expected Hardware Upgrades chart 2306 can show a breakdown of the predictions for expected hardware issues on supported devices, including as an example Solid State Disk (SSD) Drive prediction 2325, which may indicate devices that are likely to need replacement SSD drives, Memory prediction 2326, which may indicate devices that are likely to need memory upgrades, Printer Supplies prediction 2327, which may indicate devices that are likely to need additional printer supplies such as toner and paper, and Display prediction 2328, which may indicate devices that are likely to need additional or replacement displays.

The Likely Support Issues chart 2307 can show a breakdown of the predictions for expected support issues on supported devices, including as an example Wi-Fi Connection prediction 2329, which may indicate that more staffing and training may be needed to handle network hardware configuration requests, Zoom Audio Issue prediction 2330, which may indicate that increasing familiarity with the audio setup for Zoom may be required, OneDrive Sync prediction 2331, which may indicate that more expertise in OneDrive configuration on both client and server sides may be needed, and Excel Issue prediction 2332, which may indicate that more issues with Excel may be expected to be escalated to level two or level three support staff.

The Predicted Licensing Needs chart 2308 can show a breakdown of the predictions for expected additional software licenses needed on supported devices, including as an example the licenses for Zoom 2333, Tableau 2334, Acrobat 2335, and Photoshop 2336. These may be helpful for planning and negotiating software license acquisitions from vendors.

The Modeled User Personalization chart 2309 can show a breakdown of the types of end users that are utilizing supported devices, based on the event streams observed on the devices. For example, the chart 2309 may show Tech 2313, which may be engineers and developers, Sales 2314, which may be sales staff, Support 2315, which may be customer support staff, Market 2316, which may be marketing personnel, Admin 2317, which may be internal support and administrative staff, Finance 2318, which may be employees ultimately reporting to the Chief Financial Officer (CFO), and Exec 2319, which may be members of the C-Suite of the company (Chief Executive Officer, Chief Financial Officer, Chief Technical Officer, and so on). The pie chart 2311 can show a visual representation of the distribution of these end user classes. Since the classifications can be based on the way the devices are being used, they may be more accurate than classifications based on manually maintained directories.

The Modeled Device Personalization chart 2310 can show a breakdown of the types of devices that are being supported, based on the event streams observed on the devices. For example, the chart 2310 may show Desktop 2320, Laptop 2321, Mobile 2322, Server 2323, and IoT 2324. The pie chart 2312 can show a visual representation of the distribution of these device types. Since the classifications can be based on the way the devices are being used, they may be more accurate than classifications based on hardware model numbers.

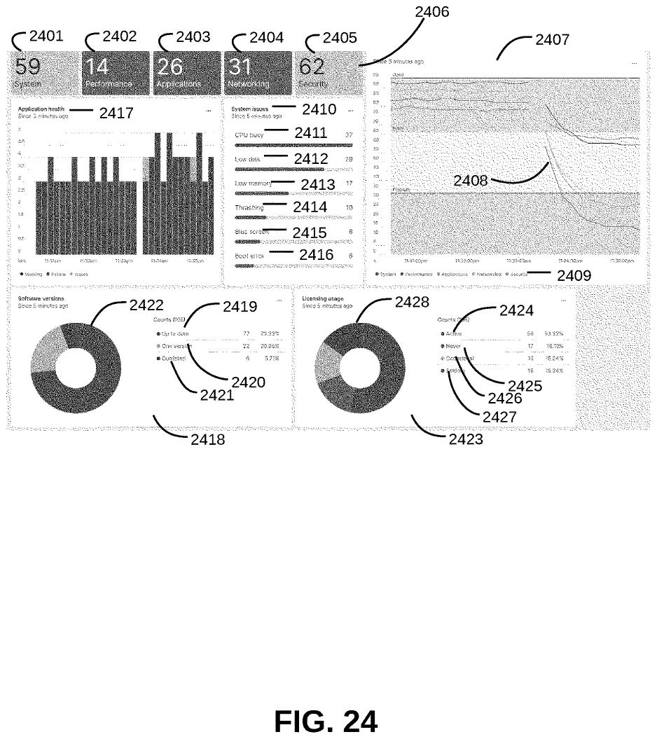

FIG. 24 is an illustration of the user interface of a dashboard displaying device information based on end user devices that are encountering significant support issues, in accordance with some embodiments of the present invention. The line 2406 of overview scores 2401-2405 may correspond to the line 2106 of overview scores 2101-2105 depicted in FIG. 21. The score graph 2407 with elements 2408-2409 may correspond to the score graph 2107 with elements 2108-2109 depicted in FIG. 21. The Application Health graph 2417 may correspond to the Application Health graph 2117 depicted in FIG. 21. The System Issues table 2410 with elements 2411-2416 may correspond to the System Issues table 2110 with elements 2111-2116 depicted in FIG. 21. The Software Versions plot 2418 with elements 2419-2422 may correspond to the Software Versions plot 2118 with elements 2119-2122 depicted in FIG. 21. The Licensing Usage plot 2423 with elements 2424-2428 may correspond to the Licensing Usage plot 2123 with elements 2124-2128 depicted in FIG. 21.

The description of the operation of the elements in FIG. 24 may be similar to the corresponding elements of FIG. 21, so a detailed description could be redundant. Instead, a description of some of the differences with FIG. 21 will be provided. For example, FIG. 24 may depict a situation where a significant software update has been deployed and the deployment is causing numerous support issues. The score graph 2407 can show a degradation over time of all the scores 2408, and the line 2406 of scores shows that all the scores 2401-2405 are low enough to be in the “warning” range. For example, the System score 2401 may indicate that the software update is causing system issues such as increased operating system faults, the Performance score 2402 may indicate that the software update is causing the devices to spend much more time on the side effects caused by the update, the Applications score 2403 may indicate that applications are not running as well and are exiting unexpectedly more frequently as a result of the update, the Networking score 2404 may indicate that network performance is suffering as a result of the update, perhaps due to increased network activity from side effects of the update, and the Security score 2405 may indicate that more unpatched vulnerabilities on devices are being exposed as a result of the update.

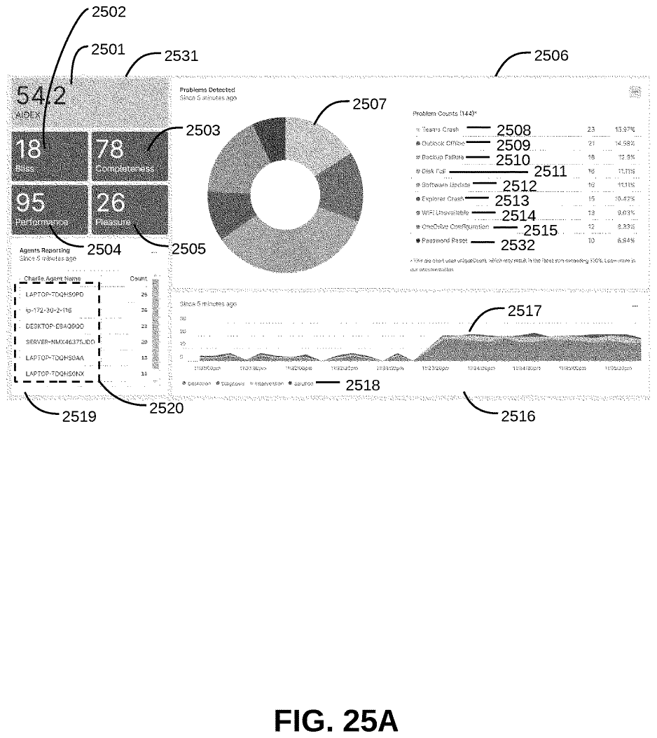

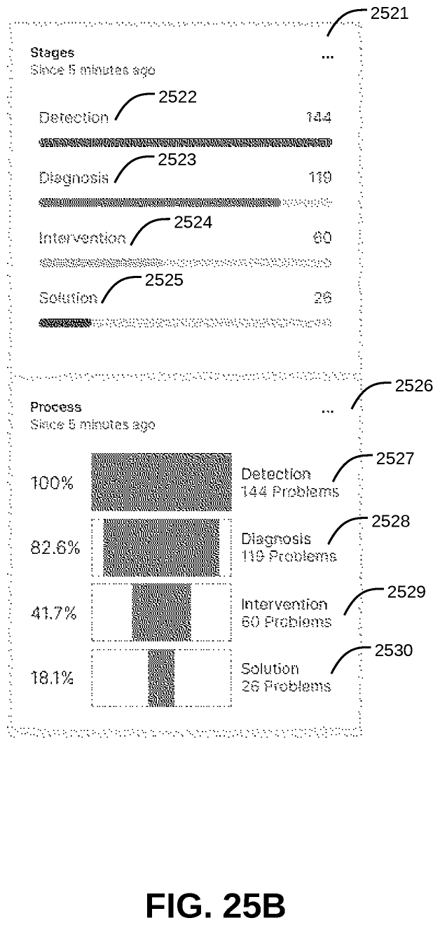

FIGS. 25A and 25B are illustrations of the user interface of a dashboard displaying support automation information based on end user devices that are encountering significant support issues, in accordance with some embodiments of the present invention. In FIG. 25A, the section 2531 of overview scores 2501-2505 may correspond to the section 2231 of overview scores 2201-2205 depicted in FIG. 22A. The Problems Detected display 2506 with elements 2507-2515 and 2532 may correspond to the Problems Detected display 2206 with elements 2207-2215 depicted in FIG. 22A. The solution graph 2516 with elements 2517-2518 may correspond to the solution graph 2216 with elements 2217-2218 depicted in FIG. 22A. The Agents Reporting table 2519 with element 2520 may correspond to the Agents Reporting table 2219 with element 2220 depicted in FIG. 22A. In FIG. 25B, the Stages chart 2521 with elements 2522-2525 may correspond to the Stages chart 2221 with elements 2222-2225 depicted in FIG. 22B. The Process chart 2526 with elements 2527-2530 may correspond to the Process chart 2226 with elements 2227-2230 depicted in FIG. 22B.

The description of the operation of the elements in FIGS. 25A and 25B may be similar to the corresponding elements of FIGS. 22A and 22B, so a detailed description could be redundant. Instead, a description of some of the differences with FIGS. 22A and 22B will be provided. For example, FIGS. 25A and 25B may depict a situation where a significant software update has been deployed and the deployment is causing numerous support issues. In FIG. 25A, the AIDEX score 2501 can give an overall indication that the devices are encountering increased support issues. The Bliss score 2502 may indicate that fewer of the support issues being encountered are being solved automatically. The Pleasure score 2505 may indicate that end users are submitting more tickets that are not yet being resolved with automated solutions. The Completeness score 2503 may indicate that the existing automated solutions are not covering the support issues being encountered by end users. The Problems Detected display 2506 may indicate that the number and distribution of problems being detected has changed, for example, there may be an increase in detected problems, and the top problems such as Teams Crash 2508 and Outlook Offline 2509 may be more prevalent. The solution graph 2516 may display the increase in problems 2517 more graphically. In FIG. 25B, the Stages chart 2521 and Process chart 2526 may indicate that of the problems being detected and diagnosed, fewer of them have solutions 2524 and 2529 available, and even fewer of them are able to successfully apply the solutions and verify them 2525 and 2530.

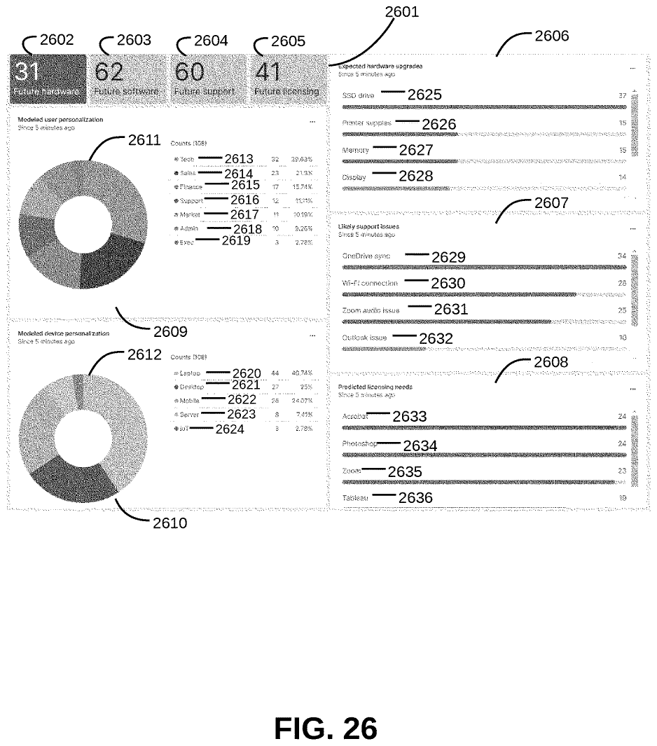

FIG. 26 is an illustration of the user interface of a dashboard displaying predictions for support needs based on end user devices that are encountering significant support issues, in accordance with some embodiments of the present invention. The section 2601 of prediction scores 2602-2605 may correspond to the section 2301 of prediction scores 2302-2305 depicted in FIG. 23. The Expected Hardware Upgrades chart 2606 with elements 2625-2628 may correspond to the Expected Hardware Upgrades chart 2306 with elements 2325-2328 depicted in FIG. 23. The Likely Support Issues chart 2607 with elements 2629-2632 may correspond to the Likely Support Issues chart 2307 with elements 2329-2332 depicted in FIG. 23. The Predicted Licensing Needs chart 2608 with elements 2633-2636 may correspond to the Predicted Licensing Needs chart 2308 with elements 2333-2336 depicted in FIG. 23. The Modeled User Personalization chart 2609 with elements 2611 and 2613-2619 may correspond to the Modeled User Personalization chart 2309 with elements 2311 and 2313-2319 depicted in FIG. 23. The Modeled Device Personalization chart 2610 with elements 2612 and 2620-2624 may correspond to the Modeled Device Personalization chart 2310 with elements 2312 and 2320-2324 depicted in FIG. 23.

The description of the operation of the elements in FIG. 26 may be similar to the corresponding elements of FIG. 23, so a detailed description could be redundant. Instead, a description of some of the differences with FIG. 23 will be provided. For example, FIG. 26 may depict a situation where a significant software update has been deployed and the deployment is causing numerous support issues. The Future Hardware score 2602 may indicate that the update has resulted in predictions for additional hardware upgrades, for example, the update may cause the devices to require more memory in order to run properly. The Expected Hardware Upgrades chart 2606 may provide more details about the predictions for additional hardware upgrades. The Future Software score 2603 may indicate that the update may cause the devices to require additional software upgrades in order to have up-to-date software, for example, the update may provide the capability for additional features in other applications after further updates. The Future Support score 2604 may indicate that the update may cause a requirement for more end user support on devices, for example, the update may require some driver configuration changes that may not be candidates for support automation. The Likely Support Issues chart 2607 may provide more details about the predictions for end user support. The Future Licensing score 2605 may indicate that new or modified licenses may be needed for the applications on devices, for example, the update may enable additional features in other applications that may require an updated license to use. The Predicted Licensing Needs chart 2608 may provide more details about the predictions for licensing.

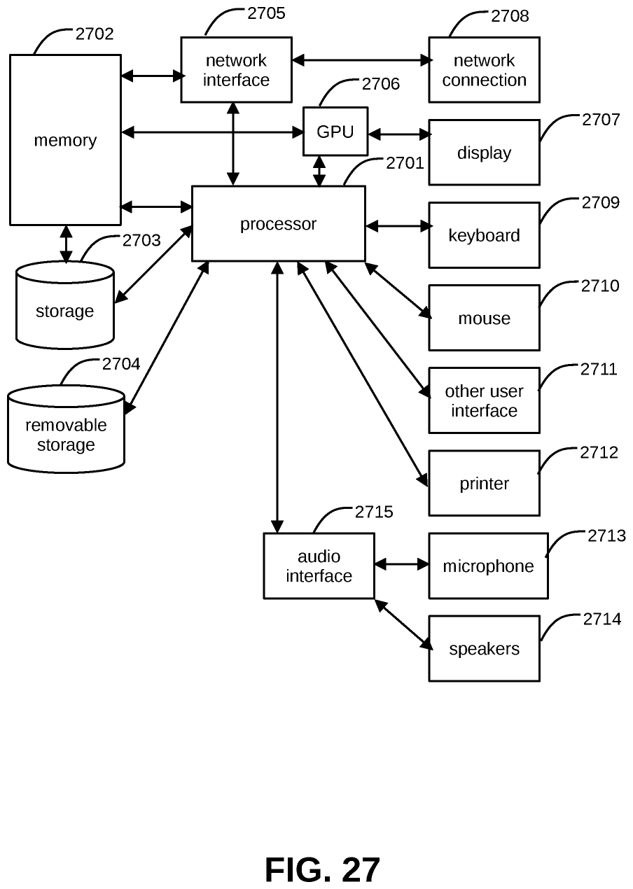

FIG. 27 is a block diagram illustrating the architecture for a computing device, in accordance with some embodiments of the present invention. Processor 2701 can control the device, and can execute instructions to implement the operating system and applications. The computing device may have multiple instances of the processor 2701, and the multiple instances may cooperate to control the device. Memory 2702 can store instructions and data for use by the processor 2701 and other components. Storage 2703 can also store instructions and data and may implement the storage in a way that allows more storage but slower access than memory 2702. Removable storage 2704 can also store instructions and data and may be removed from and connected to the computing device. Peripherals 2707-2714 can include a network connection 2708, display 2707, keyboard 2709, mouse 2710, other user interface peripherals 2711, printer 2712, microphone 2713, speakers 2714, and any other peripherals (not pictured) used by the computing device. The computing device may also have multiple instances of any of these peripherals 2707-2714. The network connection 2708 may provide access to a computer network. The display 2707 may provide a visual display of data. The keyboard 2709 may allow character input of data. The mouse 2710 may allow spatial input of data. The printer 2712 may provide hard copy output of data. The microphone 2713 may allow audio input of data. The speakers 2714 may provide audio output of data. Additional peripherals 2711 may include any other types of implementations to provide input or output of data, such as joysticks, cameras, gyroscopes, and so on. The network interface 2705 may manage the data transfers between the network connection 2708 and the processor 2701 and memory 2702. The graphic processing unit (GPU) 2706 may manage the data transfers between the display 2707 and the processor 2701 and memory 2702. The GPU 2706 may also be used by the processor 2701 as a coprocessor. The audio interface 2715 may manage the data transfers between the microphone 2713 and speakers 2714 and the processor 2701 and memory 2702.

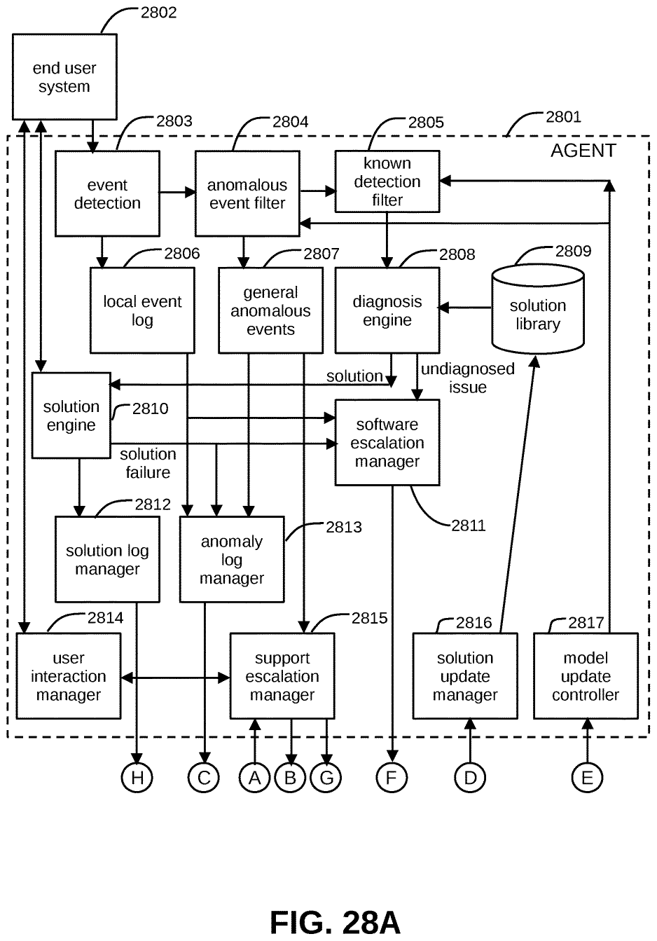

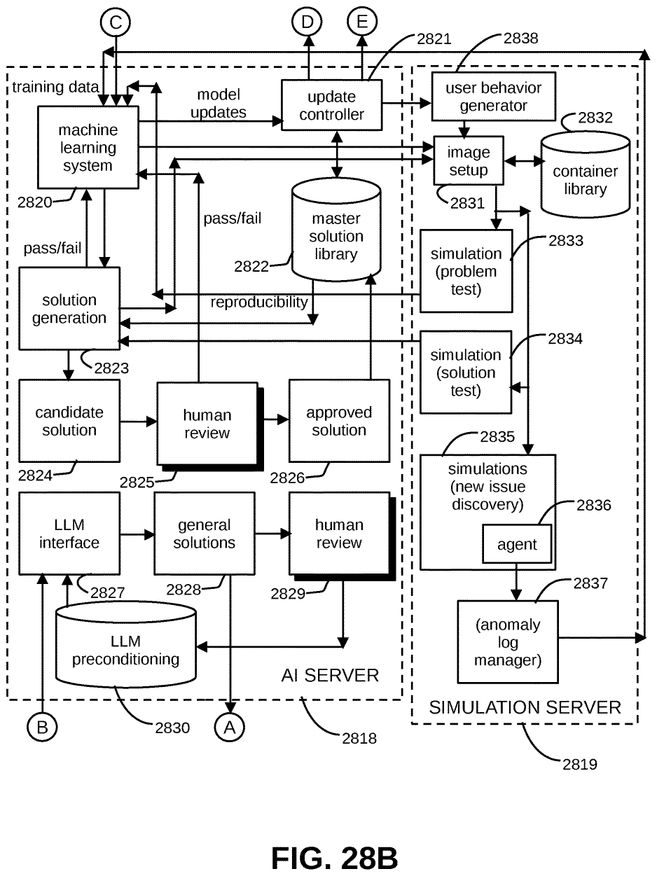

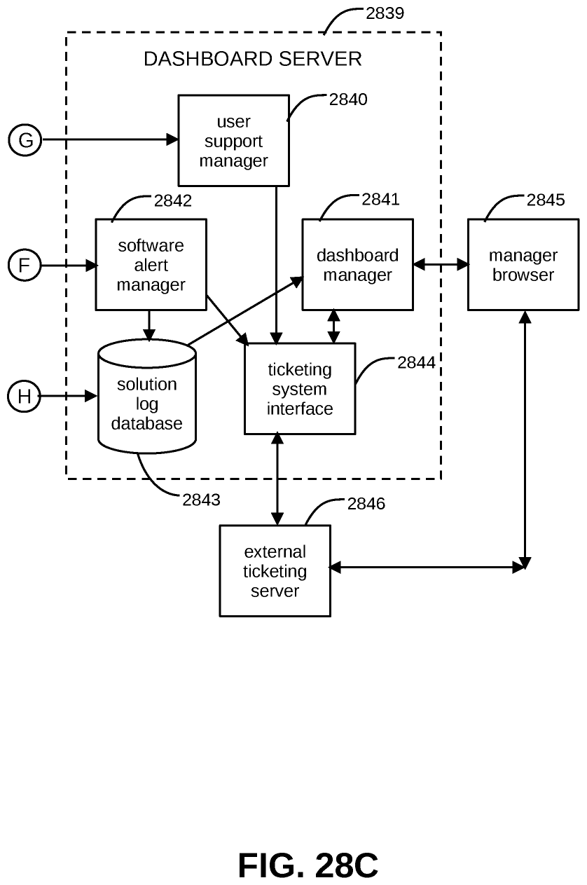

The computing device depicted in FIG. 27 may correspond to the processor 201 depicted in FIG. 2, the server 601 depicted in FIG. 6, the dashboard server 802 depicted in FIG. 8, the host 909, virtual machines 901-902, and physical machines 903-904 depicted in FIG. 9, the simulation instance 1001 depicted in FIG. 10, the simulation system 1709 depicted in FIG. 17, the AI engine 1905 and simulation systems 1903, 1907, and 1911 depicted in FIG. 19, the end user system 2802 depicted in FIG. 28A, the machine learning system 2820, AI server 2818, simulation server 2819, and simulations 2833-2835 depicted in FIG. 28B, and the dashboard server 2839, external ticketing server 2846, and manager browser 2845 depicted in FIG. 28C, along with any other computing devices that are implicitly or explicitly described in this disclosure.

The one or more computing devices described above do not need to be physically proximate to each other or in the same machine farm. Thus, the computing devices logically grouped as a machine farm may be interconnected using a wide-area network (WAN) connection or a metropolitan-area network (MAN) connection. For example, a machine farm may include computing devices physically located in different continents or different regions of a continent, country, state, city, campus, or room. Data transmission speeds between computing devices in the machine farm can be increased if the computing devices are connected using a local-area network (LAN) connection or some form of direct connection.

Management of the computing devices may be de-centralized. For example, one or more computing devices may comprise components, subsystems and circuits to support one or more management services. In one of these embodiments, one or more computing devices provide functionality for management of dynamic data, including techniques for handling failover, data replication, and increasing robustness. Each computing device may communicate with a persistent store and, in some embodiments, with a dynamic store.

A computing device may include a desktop computer, laptop computer, notebook computer, tablet computer, mobile or portable computer, mobile phone, smartphone, personal digital assistant (PDA), Internet of Things (IoT) device, wearable device, file server, application server, web server, proxy server, appliance, network appliance, gateway, gateway server, virtualization server, deployment server, secure sockets layer virtual private network (“SSL VPN”) server, firewall, or any other computing device. In one embodiment, the computing device may be referred to as a remote machine or a node. In one embodiment, the computing device may be referred to as a cloud.

The one or more computing devices described above may communicate using a network. The network can include a local-area network (LAN), such as a company Intranet, a metropolitan area network (MAN), or a wide area network (WAN), such as the Internet or the World Wide Web. In some embodiments, there are multiple networks between the devices and the computing devices. In one of these embodiments, the network may be a public network, a private network, or may include combinations of public and private networks.

The network may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network may include a wireless link, such as an infrared channel or satellite band. The topology of the network may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some embodiments, different types of data may be transmitted via different protocols. In other embodiments, the same types of data may be transmitted via different protocols.

The system and its components, such as the one or more computing devices described above, may include hardware elements, such as one or more processors, logic devices, or circuits. For example, the system and its components may include a bus or other communication component for communicating information and a processor or processing circuit coupled to the bus for processing information. The hardware elements can also include one or more processors or processing circuits coupled to the bus for processing information. The system also includes main memory, such as a random-access memory (RAM) or other dynamic storage device, coupled to the bus for storing information, and instructions to be executed by the processor. Main memory can also be used for storing position information, temporary variables, or other intermediate information during execution of instructions by the processor. The system may further include a read only memory (ROM) or other static storage device coupled to the bus for storing static information and instructions for the processor. A storage device, such as a solid-state device, magnetic disk or optical disk, can be coupled to the bus for persistently storing information and instructions.

According to various embodiments, the processes described herein can be implemented by the system or hardware components in response to the one or more processors executing an arrangement of instructions contained in memory. Such instructions can be read into memory from another computer-readable medium, such as a storage device.

Execution of the arrangement of instructions contained in memory causes the system to perform the illustrative processes described herein. One or more processors in a multi-processing arrangement may also be employed to execute the instructions contained in memory. In alternative embodiments, hard-wired circuitry may be used in place of or in combination with software instructions to effect illustrative embodiments. Thus, embodiments are not limited to any specific combination of hardware circuitry and software. To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback: and input from the user can be received in any form, including acoustic, speech, or tactile input.

FIG. 28A is a block diagram illustrating the local agent architecture, in accordance with some embodiments of the present invention. The end user supported device 2802 can be used to run the agent 2801. An event detection module 2803 can generate events from system events and pass these to an anomalous event filter 2804 and a known detection filter 2805, as well as a local event log 2806 that can store the detected events along with time stamps and other system information. The known detection filter 2805 can pass information about known sequences of events to a diagnosis engine 2808 that can make a further diagnosis of support issues using a local solution library 2809 and pass information about a known solution to a solution engine 2810 that can apply a known solution to a problem on the device 2802 and record that operation using a solution log manager 2812. The solution log manager 2812 can process the information and transmit it to a solution log database 2843 (in FIG. 28C, through “H”). If the diagnosis engine 2808 is not able to diagnose an issue, it can pass the information on to a software escalation manager module 2811, which can process it and escalate the issue for further attention through a software alert manager 2842 (in FIG. 28C, through “F”). The anomalous event filter 2804 can detect general anomalous events, such as error dialogs, error messages, error logs, audible warnings, system faults, application faults, unexpected application exits, ticket submissions, repeated end user behavior, or any other anomalous events, and pass this information to a support escalation manager module 2815 as well as recording the anomalous events using an anomaly log manager 2813. The anomaly log manager can process the anomaly information and transmit it to a machine learning system 2820 (in FIG. 28B, through “C”) where it may be used as training data. If the solution engine 2810 fails to successfully apply a solution, it can log this information using the solution log manager 2812 and pass the information to the software escalation manager 2811 as an unsolved issue.

The end user can interact with the agent through a user interaction manager module 2814, which may use a natural language interface, or may use a structured ticket submission interface, or both. The user interaction manager 2814 can communicate with the support escalation manager 2815. In the case of natural language requests, the support escalation manager may communicate with an LLM interface 2827 (in FIG. 28B, through “A” and “B”), in order to better understand and process the request. The LLM interface may also be able to provide suggestions for general solutions 2828 (in FIG. 28B), which may help the end user with issues. The support escalation manager 2815 may communicate with a user support manager 2840 (in FIG. 28C, through “G”), which may in turn use a ticketing system interface 2844 to submit and manage tickets in an external ticketing server 2846 (both in FIG. 28C).

A solution update manager module 2816 and a model update controller 2817 can receive update information from an update controller 2821 (in FIG. 28B, through “D” and “E”). The solution update manager 2816 can receive new solutions for automation of new support solutions and can update the local solution library 2809 using the information. The module update controller 2817 can receive filter parameters and machine learning model parameters and can update the anomalous event filter 2804 and known detection filter 2805 with the information.

FIG. 28B is a block diagram illustrating the AI server architecture and simulation server architecture, in accordance with some embodiments of the present invention. A machine learning system 2820 can use data from simulation results 2833 for reproducing problems, anomaly logs 2837 from simulated users, and anomaly logs 2813 from actual users (in FIG. 28A, through “A”) to control a solution generation module 2823 to generate new solutions. The solution generation module 2823 can also provide feedback to the machine learning system 2820 with information about the success of testing the solution in simulation 2834, to further improve the process of generating new solutions. The machine learning system 2820 and solution generation system 2823 can each include binary classifiers, multi-valued classifiers, perceptrons, deep learning models, feed-forward networks, recurrent networks, modular networks, radial basis function networks, liquid state machines, residual networks, transformer networks, convolutional networks, long short-term memory networks, adversarial networks, autoencoders, sequence learning models, capsule networks, large language models, generative networks, or any other type of machine learning implementations. The machine learning system 2820 and solution generation module 2823 may also be implemented using human labor, or human labor with AI (“copilot”) assistance. Using human labor for either or both of the machine learning system 2820 and solution generation module 2823 may prevent some of the automation processes described with respect to FIGS. 28A, 28B, and 28C. The solution generation module 2823 can use an image setup module 2831 in the simulation server 2819 to run a simulation 2834 to test a solution and provide feedback on the result of the testing. The interaction between the solution generation module 2823 and the simulation 2834 may be considered to be a generative adversarial network (GAN), where the solution generator module 2823 is the generator and the simulation 2834 is the discriminator. Once a candidate solution 2824 is found that meets the testing criteria in the simulation 2834, the candidate solution 2824 may be reviewed by a human 2825 who may provide additional feedback to the machine learning system 2820 and may approve the solution 2826 for entry into the master solution library 2822. This may initiate a process to use the update controller 2821 to update the local solution libraries 2809 on agents through their solution update managers 2816 (both in FIG. 28A, through “D”).

As mentioned previously, the LLM interface 2827 may use natural language requests to generate general solutions 2828 to provide to end users for general support. These solutions may be reviewed by a human 2829 before providing them to end users, and may also provide insights for modifying the LLM preconditioning 2830, which may also be known as the “prompts” for the LLM.

The simulation server 2819 can use an image setup module 2831 to configure and operate simulations 2833-2835. The image setup module 2831 may use containers from a container library 2832 to manage the setup of multiple configurations, and may use a user behavior generator 2838 to operate the simulated actions on the simulations 2833-2835. Simulation 2833 may be used to duplicate and test a problem that has previously occurred. As previously described, simulation 2834 may be used to test a proposed solution to see how it operates. Simulation 2835 may be used to simulate generic end user behavior and monitor for new problems that occur, using an agent 2836 that can generate an anomaly log with anomaly log manager 2837. Agent 2836 may correspond to agent 2801 in FIG. 28A, and anomaly log manager 2837 may correspond to anomaly log manager 2813 in FIG. 28A.

FIG. 28C is a block diagram illustrating the dashboard server architecture, in accordance with some embodiments of the present invention. A dashboard server 2839 can contain a solution log database 2843 that stores information about the use of support automation. A dashboard manager 2841 can be used to access the data in the solution log database 2843, and can also use a ticketing system interface 2844 to update an external ticketing server 2846. A manager can use a browser 2845 to interact with both the dashboard manager 2841 and the external ticketing server 2846. As described previously, a user support manager 2840 and software alert manager 2842 can also use information from an agent to update the external ticketing server 2846 through the ticketing system interface 2844. The software alert manager 2842 can also modify the solution log database 2843 to record alerts.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by or to control the operation of data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer Storage medium can also be, or be included in, one or more separate components or media (e.g., multiple CDs, disks, or other storage devices).

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs. etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as Python, JavaScript, PHP, Go, Ruby, Ruby on Rails, Rust, Swift, Objective C, LISP, Perl, BASIC, Visual Basic, R, C, C++, C #, Prolog, FORTRAN, COBOL, APL, or in any byte code language such as Java, or in any database implementation language such as SQL. The software programs may be stored on or in one or more articles of manufacture as object code.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

While this specification contains many specific implementation details, these should not be construed as limitations on the scope of any inventions or of what may be claimed, but rather as descriptions of features specific to particular implementations of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of simulating a device comprising:
receiving, from an agent on the device, a configuration and an event stream;
deploying a simulation based on the configuration;
invoking a plurality of actions on the simulation based on the event stream;
recording a plurality of events on the simulation resulting from the plurality of actions; and
writing the plurality of events into a database; wherein:
the configuration is based on a device configuration of the device; and
the event stream is based on a plurality of events on the device.

2. The method of claim 1, further comprising:
maintaining a plurality of containers in a second database; and
using the plurality of containers for the deploying.

3. The method of claim 1, further comprising:
identifying, based on the configuration, a root cause of a problem;
identifying, based on the event stream, a solution for the problem; and
creating, based on the root cause and the solution, a script.

4. The method of claim 3, wherein the script is configured to:
initialize a detection of an event based on the problem;
diagnose, based on the detection, the problem;
apply, based on the diagnosis, the solution; and
determine, based on the application, a success indicator for the solution.

5. The method of claim 3, further comprising:
deploying a second simulation based on the configuration;
running the script on the second simulation;
invoking a second plurality of actions on the second simulation based on the event stream; and
determining a success indicator for the script.

6. The method of claim 5, further comprising:
configuring a generative adversarial network; and
applying the generative adversarial network until the success indicator indicates that the script solves the problem; wherein:
the creating of the script is a generator of the generative adversarial network; and
the second simulation is a discriminator of the generative adversarial network.

7. The method of claim 1, wherein each action in the plurality of actions is selected from the group of an action from the event stream, a random action, and a parametric action.

8. The method of claim 7, further comprising:
invoking the plurality of actions on a second simulation based on the configuration;
detecting, based on second simulation, a problem;
identifying, based on second simulation, a root cause of the problem;
creating, based on the root cause and a database of known solutions, a script;
running the script on a third simulation based on the configuration;
invoking a second plurality of actions on the third simulation based on the second simulation;
determining a success indicator for the script; and
applying a generative adversarial network until the success indicator indicates that the script solves the problem; wherein:
the creating of the script is a generator of the generative adversarial network; and
the second simulation is a discriminator of the generative adversarial network.

9. The method of claim 1, further comprising:
detecting, based on the event stream, a problem;
identifying, based on the configuration, a root cause of the problem;
creating, based on the root cause and a database of known solutions, a script;
running the script on a second simulation based on the configuration;
invoking a second plurality of actions on the second simulation based on the event stream;
determining a success indicator for the script; and
applying a generative adversarial network until the success indicator indicates that the script solves the problem; wherein:
the creating of the script is a generator of the generative adversarial network; and
the second simulation is a discriminator of the generative adversarial network.

10. A system for simulating a first device comprising:
a second device including a processor and a memory, configured to:
receive, from an agent on the first device, a configuration and an event stream;
deploy a simulation based on the configuration;
invoke a plurality of actions on the simulation based on the event stream;
record a plurality of events on the simulation resulting from the plurality of actions; and
write the plurality of events into a database; wherein:
the configuration is based on a device configuration of the first device; and
the event stream is based on a plurality of events on the first device.

11. The system of claim 10, wherein the second device is further configured to:
maintain a plurality of containers in a second database; and
use the plurality of containers for the deploying.

12. The system of claim 10, wherein the second device is further configured to:
identify, based on the configuration, a root cause of a problem;
identify, based on the event stream, a solution for the problem; and
create, based on the root cause and the solution, a script.

13. The system of claim 12, wherein the script is configured to:
initialize a detection of an event based on the problem;
diagnose, based on the detection, the problem;
apply, based on the diagnosis, the solution; and
determine, based on the application, a success indicator for the solution.

14. The system of claim 12, wherein the second device is further configured to:
deploy a second simulation based on the configuration;
run the script on the second simulation;
invoke a second plurality of actions on the second simulation based on the event stream; and
determine a success indicator for the script.

15. The system of claim 14, wherein the second device is further configured to:
configure a generative adversarial network; and
apply the generative adversarial network until the success indicator indicates that the script solves the problem; wherein:
the creating of the script is a generator of the generative adversarial network; and
the second simulation is a discriminator of the generative adversarial network.

16. The system of claim 10, wherein each action in the plurality of actions is selected from the group of an action from the event stream, a random action, and a parametric action.

17. The system of claim 16, wherein the second device is further configured to:
invoke the plurality of actions on a second simulation based on the configuration;
detect, based on second simulation, a problem;
identify, based on second simulation, a root cause of the problem;
create, based on the root cause and a database of known solutions, a script;
run the script on a third simulation based on the configuration;
invoke a second plurality of actions on the third simulation based on the second simulation;
determine a success indicator for the script; and
apply a generative adversarial network until the success indicator indicates that the script solves the problem; wherein:
the creating of the script is a generator of the generative adversarial network; and
the second simulation is a discriminator of the generative adversarial network.

18. The system of claim 10, wherein the second device is further configured to:
detect, based on the event stream, a problem;
identify, based on the configuration, a root cause of the problem;
create, based on the root cause and a database of known solutions, a script;
run the script on a second simulation based on the configuration;
invoke a second plurality of actions on the second simulation based on the event stream;
determine a success indicator for the script; and
apply a generative adversarial network until the success indicator indicates that the script solves the problem; wherein:
the creating of the script is a generator of the generative adversarial network; and
the second simulation is a discriminator of the generative adversarial network.

19. A non-transitory computer-readable medium having data stored therein representing software executable by a computer, the software including instructions for simulating a device comprising:
receiving, from an agent on the device, a configuration and an event stream;
deploying a simulation based on the configuration;
invoking a plurality of actions on the simulation based on the event stream;
recording a plurality of events on the simulation resulting from the plurality of actions; and
writing the plurality of events into a database; wherein:
the configuration is based on a device configuration of the device; and
the event stream is based on a plurality of events on the device.

20. The non-transitory computer-readable medium of claim 19, further including instructions comprising:
detecting, based on the event stream, a problem;
identifying, based on the configuration, a root cause of the problem;
creating, based on the root cause and a database of known solutions, a script;
running the script on a second simulation based on the configuration;
invoking a second plurality of actions on the second simulation based on the event stream;
determining a success indicator for the script; and
applying a generative adversarial network until the success indicator indicates that the script solves the problem; wherein:
the creating of the script is a generator of the generative adversarial network; and
the second simulation is a discriminator of the generative adversarial network.
